(19) United States
(12) Patent Application Publication
(10) Pub. No.: US 2026/0242891 A1
(43) Pub. Date: Aug. 20, 2026

(54) FUNCTIONALIZED RESINS FOR LITHIUM CAPTURE

(71) Applicant: BOARD OF REGENTS, THE UNIVERSITY OF TEXAS SYSTEM, Austin, TX (US)

(72) Inventors: Jonathan L. SESSLER, Austin, TX (US); Zachariah PAGE, Austin, TX (US); Sheng-Yin HUANG, Austin, TX (US); Hu WANG, Austin, TX (US)

(21) Appl. No.: 18/876,794

(22) PCT Filed: Jun. 20, 2023
(86) PCT No.: PCT/US2023/068737

§ 371 Date: Dec. 19, 2024

Related U.S. Application Data
(60) Provisional application No. 63/353,815, filed on Jun. 20, 2022.

(51) Int. Cl. C22B 7/00; C22B 26/12

(52) U.S. Cl. CPC C22B 7/006; C22B 26/12

(57) ABSTRACT

The present disclosure relates to functionalized supports for the separation of metal ions from a recycling solution such as from a battery. In particular, these resins may be used in capture methods that make use of solvent polarity such as switching from an aprotic solvent to a protic solvent to facilitate separation of the desired metals. These methods may be particularly useful for the separation of lithium, cobalt, nickel, and lanthanum from composition from batteries.

This application claims the benefit of priority to U.S. Provisional Application No. 63/353,815, filed on Jun. 20, 2022, the entire contents of which are hereby incorporated by reference.

### BACKGROUND OF THE INVENTION

### 1. Field of the Invention

The present disclosure relates generally to the fields of chemistry, metal extraction, and solvometallurgy. The present disclosure relates to resins for use in methods of purifying metals based upon solvent polarity.

### 2. Description of Related Art

Modern society relies heavily on lithium-ion batteries (Tollefson, 2008; Masias et al., 2021). Unfortunately, supplies of lithium, like other critical materials can be compromised as the result of political tensions and economic fluctuations (Murdock et al., 2021; Olivetti et al., 2017; Helbig et al., 2018). Not surprisingly, therefore, extraction of lithium (and other metals) from spent lithium-ion batteries (LIB) is receiving increasing attention as an alternative to ore mining (Harper et al., 2019; Thompson et al., 202; Huang et al., 2018; Zeng et al., 2014; Bae and Kim, 2021; Li et al., 2021). However, LIB recycling levels are currently low (≤5% as a general rule). These adaptation-related problems are compounded by several unsolved technical challenges. For instance, lithium hexafluorophosphate (LiPF₆), the dominant conducting salt present in commercial LIBs (Younesi et al., 2015), is hydrolytically unstable and cannot be recovered directly using current recycling processes. It is believed that only supercritical CO₂ has been applied to recover electrolyte from spent batteries; however, it does not allow LiPF₆ to be isolated directly (Liu et al., 2014; Grützke et al., 2015).

LiPF₆ recovery presents several challenges. First, the PF₆⁻ anion is relatively large and weakly coordinating (Honeychuck and Hersh, 1989). This has made the design of receptors for the PF₆⁻ anion difficult, with only a few effective hosts being described in the literature (Hayashida et al., 2002; Fyfe et al., 1997; Lee et al., 2013; Yan et al., 2022). Second, once captured, it is necessary to devise a viable release strategy so as to obtain free LiPF₆. Third, the high reactivity of LiPF₆ and its propensity to produce hazardous by-products (e.g., fluorophosphates and HF) can require the use of special handling and impede its recycling (Terborg et al., 2013; Parimalam et al., 2017; Zheng et al., 2016). Finally, the purity of LiPF₆ obtained must be high. This is because purity directly impacts the utility of LiPF₆ as a battery material and the charging, discharging, and capacity of the LIB system as a whole (Liu et al., 2021; Campion et al., 2005). is a need for a chemical system that would allow for the safe and selective recovery of high purity LiPF₆ free of appreciable contaminants.

Therefore, there remains a need to develop a chemical system that would allow for the safe and selective recovery of high purity metals, such as LiPF₆, free of appreciable contaminants under mild conditions.

### SUMMARY OF THE INVENTION

In some aspects, the present disclosure provides functionalized resins that may be used to recycle metals from a mixture of one or more metals.

In some aspects, the present disclosure provides methods of obtaining a metal or metal salt of interest from a composition comprising at least a metal or metal salt to be purified, the method comprising:
(A) contacting the composition with a metal selective chelating agent in the presence of an aprotic solvent to form a metalated metal selective chelating agent; and
(B) exposing the metalated metal selective chelating agent to a protic solvent to form a purified metal sample.

In some embodiments, the composition is a recycling composition. In some embodiments, the composition is electronic waste. In some embodiments, the electronic waste is waste from a battery. In other embodiments, the electronic waste is waste from a battery powered device such as a laptop, a phone, a tablet, or a television. In some embodiments, the recycling composition comprises two or more additional metals or metal salts. In some embodiments, the recycling composition comprises two, three, four, five, or six additional metals or metal salts beyond the metal or metal salt to be purified.

In some embodiments, the metal or metal salt of interest is a monovalent metal salt, a divalent metal salt, or a trivalent metal salt. In some embodiments, the metal or metal salt to be purified is a monovalent metal salt. In some embodiments, the monovalent metal salt is a monovalent alkali metal salt. In some embodiments, the monovalent alkali metal salt is a lithium salt. In other embodiments, the metal to be purified is a divalent metal salt. In some embodiments, the divalent metal salt is a transition metal salt. In some embodiments, the divalent metal salt is a nickel salt. In other embodiments, the divalent metal salt is a cobalt salt. In some embodiments, the metal to be purified is an actinide or a lanthanide. In some embodiments, the metal to be purified is a lanthanide salt. In some embodiments, the metal to be purified is a trivalent lanthanide salt.

In some embodiments, the metal to be purified is a salt with a counter anion. In some embodiments, the counter anion is a weakly coordinating anion. In some embodiments, the weakly coordinating anion is bis(trifluoromethanesulfonyl)imide or hexafluorophosphate. In some embodiments, the weakly coordinating anion is hexafluorophosphate. In other embodiments, the weakly coordinating anion is bis(trifluoromethanesulfonyl)imide. In other embodiments, the counter anion is a halide such as a chloride. In other embodiments, the counter anion is a nitrate. In some embodiments, the recycling composition is from a battery.

In some embodiments, the battery is a lithium ion battery.

In some embodiments, the metal selective chelating agent comprises a chelating unit of the formula:

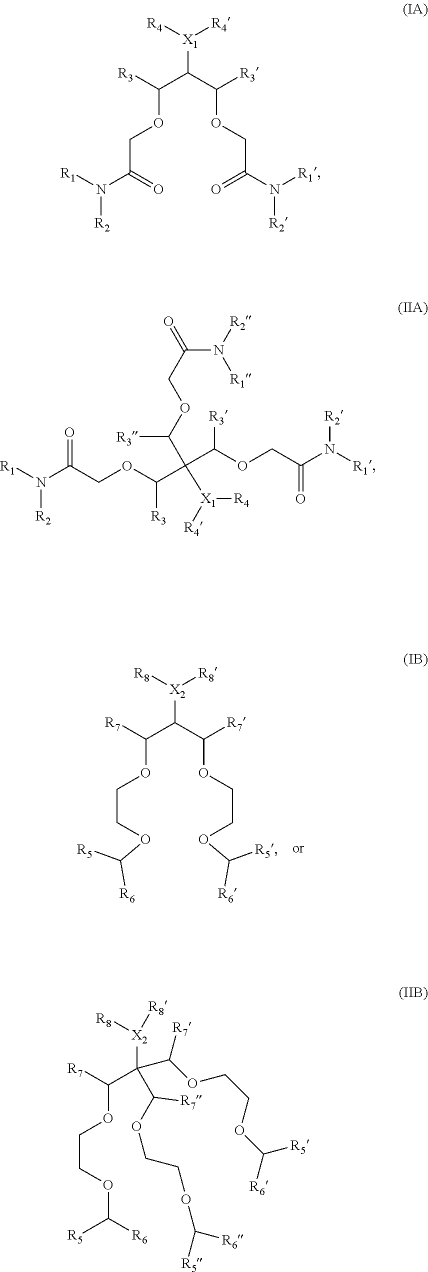

wherein:
R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₃″, R₇, R₇, and R₇″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
R₄, R₄′, R₈, and R₈′ are hydrogen, a bond to a support, or taken together as defined above; and
X₁ and X₂ are each independently O or N.

In some embodiments, the metal selective chelating agent comprises a chelating unit of the formula:

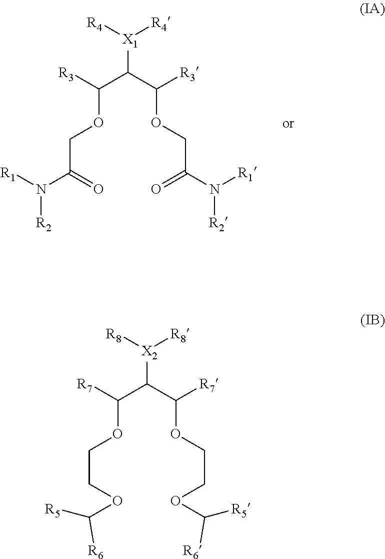

wherein:
R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₇, and R₇′ are each independently hydrogen or R₃ and R₄, R₃′ and R₄′, R₇ and R₈, or R₇′ and R₈′ are joined together to form a 3-8 membered cycloalkane ring or a 3-8 membered heterocycloalkane ring;
R₄, R₄′, R₈, and R₈′ are hydrogen, a connection to a resin or polymer, or taken together as defined above; and
X₁ and X₂ are each independently O or N.

In some embodiments, the chelating unit is further defined as:

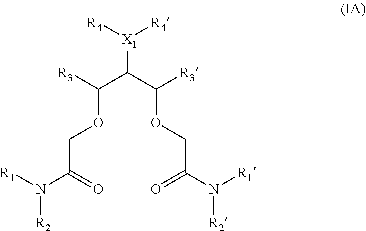

wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
R₃ and R₃′ are each independently hydrogen or R₃ and R₄ or R₃′ and R₄′ are joined together to form a 3-8 membered cycloalkane ring or a 3-8 membered heterocycloalkane ring;
R₄ and R₄′ are hydrogen, a connection to a resin or polymer, or taken together as defined above; and
X₁ is O or N.

In some embodiments, the chelating unit is further defined as:

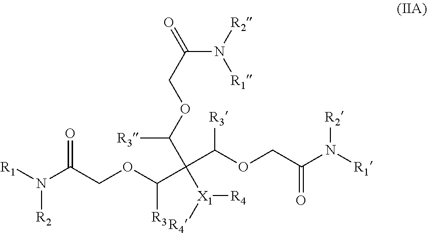

wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, and R₃″ are each independently hydrogen or R₃ and R₄, R₃′ and R₄′, and R₃″ and R₄″ are joined together to form a 3-8 membered cycloalkane ring or a 3-8 membered heterocycloalkane ring;
R₄ and R₄′ are hydrogen, a bond to a support, or taken together as defined above; and
X₁ and X₂ are each independently O or N.

In some embodiments, the chelating unit is further defined as:

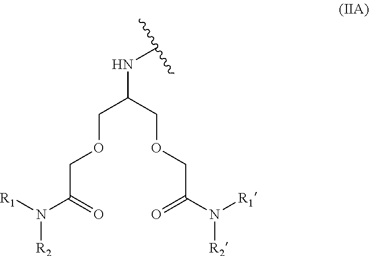

wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to the support.

In some embodiments, the chelating unit is further defined as:

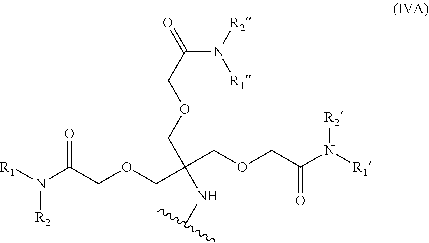

wherein:

R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and the open valance is connected to a support.

In some embodiments, the chelating unit is further defined as:

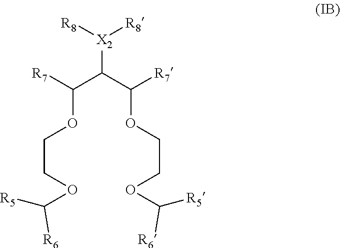

wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₇ and R₇′ are each independently hydrogen or R₇ and R₈ or R₇′ and R₈′ are joined together to form a 3-8 membered cycloalkane ring or a 3-8 membered heterocycloalkane ring;
R₈ and R₈′ are hydrogen, a connection to a resin or polymer, or taken together as defined above; and
X₂ is O or N.

In some embodiments, the chelating unit is further defined as:

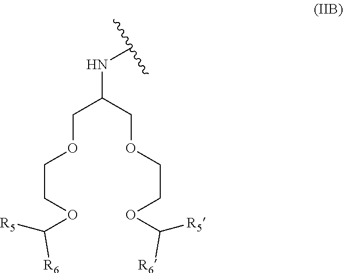

wherein:

R₅, R₅′, R₆, and R₆′ are each independently cycloalkyl_{(C≤12)}, aryl_{(C≤12)}, heteroaryl_{(C<12)}, heterocycloalkyl_{(C<12)}, or a substituted version of any of these groups; and
the open valence is connected to the support.

In some embodiments, the chelating unit is further defined as:

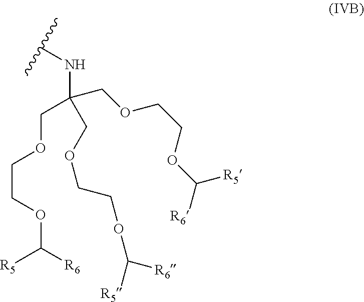

wherein:
R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

In some embodiments, R₁ is cycloalkyl_{(C≤12)} or substituted cycloalkyl_{(C≤12)}. In some embodiments, R₁ is cycloalkyl_{(C≤12)} such as cyclohexyl. In some embodiments, R₁′ is cycloalkyl_{(C≤12)} or substituted cycloalkyl_{(C≤12)}. In some embodiments, R₁′ is cycloalkyl_{(C≤12)} such as cyclohexyl. In some embodiments, R₁″ is cycloalkyl_{(C≤12)} or substituted cycloalkyl_{(C≤12)}. In some embodiments, R₁″ is cycloalkyl_{(C≤12)} such as cyclohexyl.

In some embodiments, R₂ is cycloalkyl_{(C≤12)} or substituted cycloalkyl_{(C≤12)}. In some embodiments, R₂ is cycloalkyl_{(C≤12)} such as cyclohexyl. In some embodiments, R₂′ is cycloalkyl_{(C≤12)}, or substituted cycloalkyl_{(C≤12)}. In some embodiments, R₂′ is cycloalkyl_{(C≤12)} such as cyclohexyl. In some embodiments, R₂″ is cycloalkyl_{(C≤12)} or substituted cycloalkyl_{(C≤12)}. In some embodiments, R₂″ is cycloalkyl_{(C≤12)} such as cyclohexyl.

In some embodiments, R₅ is cycloalkyl_{(C≤12)} or substituted cycloalkyl_{(C≤12)}. In some embodiments, R₅ is cycloalkyl_{(C≤12)} such as cyclohexyl. In some embodiments, R₅′ is cycloalkyl_{(C≤12)} or substituted cycloalkyl_{(C≤12)}. In some embodiments, R₅′ is cycloalkyl_{(C≤12)} such as cyclohexyl. In some embodiments, R₅″ is cycloalkyl_{(C≤12)} or substituted cycloalkyl_{(C≤12)}. In some embodiments, R₅″ is cycloalkyl_{(C≤12)} such as cyclohexyl.

In some embodiments, R₆ is cycloalkyl_{(C≤12)} or substituted cycloalkyl_{(C≤12)}. In some embodiments, R₆ is cycloalkyl_{(C≤12)} such as cyclohexyl. In some embodiments, R₆′ is cycloalkyl_{(C≤12)} or substituted cycloalkyl_{(C≤12)}. In some embodiments, R₆′ is cycloalkyl_{(C≤12)} such as cyclohexyl. In some embodiments, R₆″ is cycloalkyl_{(C≤12)} or substituted cycloalkyl_{(C≤12)}. In some embodiments, R₆″ is cycloalkyl_{(C≤12)} such as cyclohexyl.

In some embodiments, the support is a hydrophobic support. In some embodiments, the support comprises a polymer. In some embodiments, the support is a bead, resin, or surface. In some embodiments, the polymer is a hydrophobic polymer such as polystyrene.

In some embodiments, the compositions further comprise two or more chelating units attached to the support. In some embodiments, the metal selective chelating agent further comprises a capping agent on any remaining reactive functional groups on the support. In some embodiments, the chelating unit and the support are joined by a linker between the chelating unit and the support. In some embodiments, the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof. In some embodiments, the linker comprises two joining group selected from a carboxylic acid and an amine. In some embodiments, the two joining groups are both carboxylic acids. In some embodiments, the spacer is an alkanediyl_{(C≤12)} or a substituted alkanediyl_{(C≤12)}. In some embodiments, the spacer is alkanediyl_{(C≤12)} such as propanediyl.

In some embodiments, the methods are conducted at a temperature above −80° C. In some embodiments, the temperature is above −10° C. In some embodiments, the temperature is above 10° C. In some embodiments, the methods are carried out at a temperature from about −30° C. to about 100° C. In some embodiments, the temperature is from about −10° C. to about 75° C. In some embodiments, the temperature is from about 10° C. to about 40° C. In some embodiments, the temperature is from about 20° C. to about 30° C. In some embodiments, the temperature is room temperature.

In some embodiments, the aprotic solvent is an ether. In some embodiments, the ether is an oxygen containing C₃-C₈ heterocycloalkane. In some embodiments, the ether is tetrahydrofuran. In some embodiments, the ether is a C1-C12 dialkylether. In some embodiments, the aprotic solvent is a nitrogen containing solvent. In some embodiments, the nitrogen containing solvent is a C1-C8 cyanoalkane. In some embodiments, the nitrogen containing solvent is acetonitrile.

In some embodiments, the protic solvent is a hydroxy containing solvent. In some embodiments, the hydroxy containing solvent is a C1-C12 alcohol. In some embodiments, the hydroxy containing solvent is methanol. In some embodiments, the protic solvent is admixed with water. In some embodiments, the methods comprise using a solution comprising at least 90% protic solvent. In some embodiments, the solution comprises at least 95% protic solvent. In some embodiments, the solution comprises at least 98% protic solvent.

In some embodiments, the methods are conducted at a pressure from about 0.1 atm to about 5 atm. In some embodiments, the pressure is from about 0.25 atm to about 2.5 atm. In some embodiments, the pressure is from about 0.5 atm to about 2 atm. In some embodiments, the pressure is about 1 atm.

In some embodiments, the purified metal sample comprises at least 90% of the desired metal or metal salt. In some embodiments, the purified metal sample comprises at least 92.5% of the desired metal or metal salt. In some embodiments, the purified metal sample comprises at least 95% of the desired metal or metal salt. In some embodiments, the purified metal sample comprises at least 97.5% of the desired metal or metal salt. In some embodiments, the purified metal sample comprises at least 98% of the desired metal or metal salt. In some embodiments, the purified metal sample comprises at least 99% of the desired metal or metal salt.

In some aspects, the present disclosure provides compositions comprising:
(A) a support; and
(B) a chelating unit of the formula:

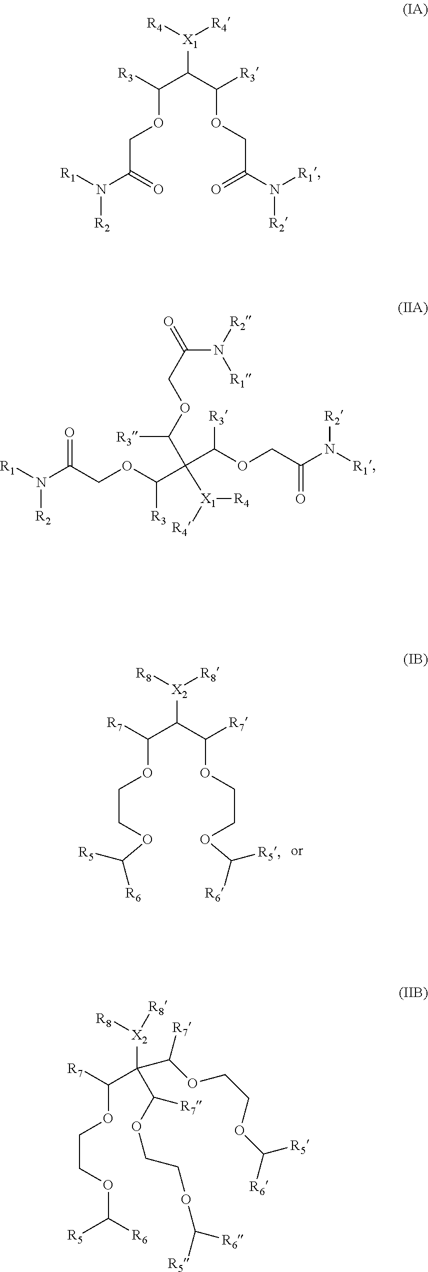

wherein:

R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₃″, R₇, R₇′, and R₇″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
R₄, R₄′, R₈, and R₈′ are hydrogen, a connection to a resin or polymer, or taken together as defined above; and
X₁ and X₂ are each independently O or N.

In some embodiments, the chelating unit is further defined as:

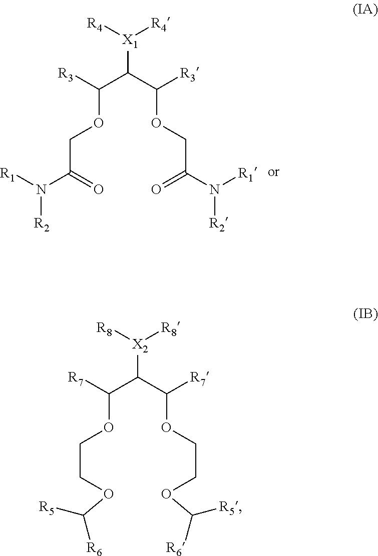

wherein:
R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₇, and R₇′ are each independently hydrogen or R₃ and R₄, R₃′ and R₄′, R₇ and R₈, or R₇′ and R₈′ are joined together to form a 3-8 membered cycloalkane ring or a 3-8 membered heterocycloalkane ring;
R₄, R₄′, R₈, and R₈′ are hydrogen, a connection to a resin or polymer, or taken together as defined above; and
X₁ and X₂ are each independently O or N.

In some embodiments, the chelating unit is further defined as:

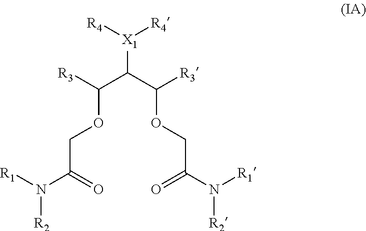

wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
R₃ and R₃′ are each independently hydrogen or R₃ and R₄ or R₃′ and R₄′ are joined together to form a 3-8 membered cycloalkane ring or a 3-8 membered heterocycloalkane ring;
R₄ and R₄′ are hydrogen, a connection to a resin or polymer, or taken together as defined above; and
X₁ is O or N.

In some embodiments, the chelating unit is further defined as:

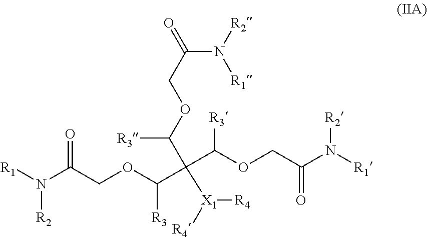

wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, and R₃″ are each independently hydrogen or R₃ and R₄, R₃′ and R₄′, and R₃″ and R₄″ are joined together to form a 3-8 membered cycloalkane ring or a 3-8 membered heterocycloalkane ring;
R₄ and R₄′ are hydrogen, a bond to a support, or taken together as defined above; and
X₁ and X₂ are each independently O or N.

In some embodiments, the chelating unit is further defined as:

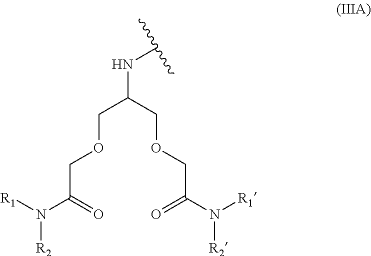

wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to the support.

In some embodiments, the chelating unit is further defined as:

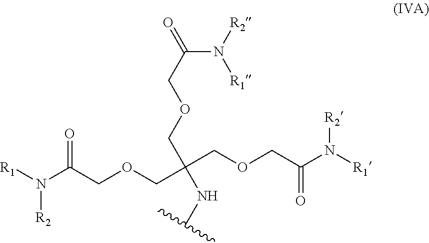

wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

In some embodiments, the chelating unit is further defined as:

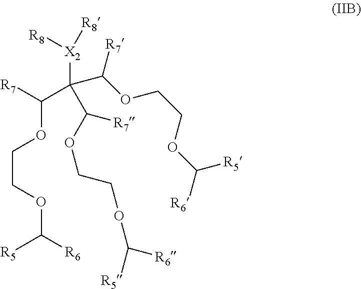

wherein:
R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₇, R₇′, and R₇″ are each independently hydrogen or R₇ and R₈, R₇′ and R₈′, or R₇″ and R₈″ are joined together to form a 3-8 membered cycloalkane ring or a 3-8 membered heterocycloalkane ring;
R₈ and R₈′ are hydrogen, a bond to a support, or taken together as defined above; and
X₁ and X₂ are each independently O or N.

In some embodiments, the chelating unit is further defined as:

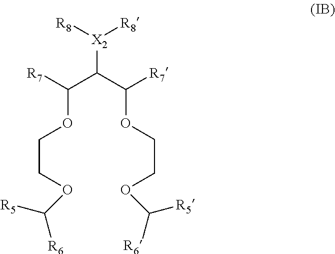

wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₇ and R₇′ are each independently hydrogen or R₇ and R₈ or R₇′ and R₈′ are joined together to form a 3-8 membered cycloalkane ring or a 3-8 membered heterocycloalkane ring;
R₈ and R₈′ are hydrogen, a connection to a resin or polymer, or taken together as defined above; and
X₂ is O or N.

In some embodiments, the chelating unit is further defined as:

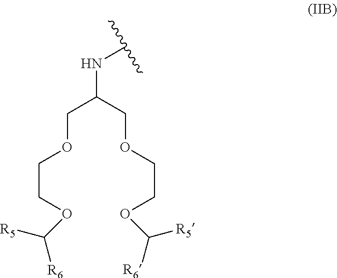

wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to the support.

In some embodiments, the chelating unit is further defined as:

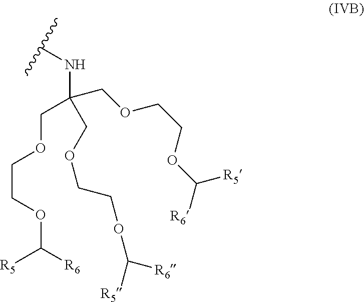

wherein:
R₅, R₅′, R₅″, R₆, R₆′, and R₆″ are each independently cycloalkyl_{(C≤12)}, aryli_{(C≤12)}, heteroaryl_{(C≤12)}, heterocycloalkyl_{(C≤12)}, or a substituted version of any of these groups; and
the open valance is connected to a support.

In some embodiments, R₁ is cycloalkyl_{(C≤12)} or substituted cycloalkyl_{(C≤12)}. In some embodiments, R₁ is cycloalkyl_{(C≤12)} such as cyclohexyl. In some embodiments, R₁′ is cycloalkyl_{(C≤12)} or substituted cycloalkyl_{(C≤12)}. In some embodiments, R₁′ is cycloalkyl_{(C≤12)} such as cyclohexyl. In some embodiments, R₁″ is cycloalkyl_{(C≤12)} or substituted cycloalkyl_{(C≤12)}. In some embodiments, R₁″ is cycloalkyl_{(C≤12)} such as cyclohexyl.

In some embodiments, R₂ is cycloalkyl_{(C≤12)} or substituted cycloalkyl_{(C≤12)}. In some embodiments, R₂ is cycloalkyl_{(C≤12)} such as cyclohexyl. In some embodiments, R₂′ is cycloalkyl_{(C≤12)} or substituted cycloalkyl_{(C≤12)}. In some embodiments, R₂′ is cycloalkyl_{(C≤12)} such as cyclohexyl. In some embodiments, R₂″ is cycloalkyl_{(C≤12)} or substituted cycloalkyl_{(C≤12)}. In some embodiments, R₂″ is cycloalkyl_{(C≤12)} such as cyclohexyl.

In some embodiments, R₅ is cycloalkyl_{(C≤12)} or substituted cycloalkyl_{(C≤12)}. In some embodiments, R₅ is cycloalkyl_{(C≤12)} such as cyclohexyl. In some embodiments, R₅′ is cycloalkyl_{(C≤12)} or substituted cycloalkyl_{(C≤12)}. In some embodiments, R₅′ is cycloalkyl_{(C≤12)} such as cyclohexyl. In some embodiments, R₅″ is cycloalkyl_{(C≤12)} or substituted cycloalkyl_{(C≤12)}. In some embodiments, R₅″ is cycloalkyl_{(C≤12)} such as cyclohexyl.

In some embodiments, R₆ is cycloalkyl_{(C≤12)} or substituted cycloalkyl_{(C≤12)}. In some embodiments, R₆ is cycloalkyl_{(C≤12)} such as cyclohexyl. In some embodiments, R₆′ is cycloalkyl_{(C≤12)} or substituted cycloalkyl_{(C≤12)}. In some embodiments, R₆′ is cycloalkyl_{(C≤12)} such as cyclohexyl. In some embodiments, R₆″ is cycloalkyl_{(C≤12)} or substituted cycloalkyl_{(C≤12)}. In some embodiments, R₆″ is cycloalkyl_{(C≤12)} such as cyclohexyl.

In some embodiments, the support is a hydrophobic support. In some embodiments, the support comprises a polymer. In some embodiments, the support is a bead, resin, or surface. In some embodiments, the polymer is a hydrophobic polymer such as polystyrene.

In some embodiments, the compositions further comprise two or more chelating units attached to the support. In some embodiments, the metal selective chelating agent further comprises a capping agent on any remaining reactive functional groups on the support. In some embodiments, the chelating unit and the support are joined by a linker between the chelating unit and the support. In some embodiments, the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof. In some embodiments, the linker comprises two joining group selected from a carboxylic acid and an amine. In some embodiments, the two joining groups are both carboxylic acids. In some embodiments, the spacer is an alkanediyl_{(C≤12)} or a substituted alkanediyl_{(C≤12)}. In some embodiments, the spacer is alkanediyl_{(C≤12)} such as propanediyl.

In still another aspects, the present disclosure provides methods of purifying a metal or metal salt comprising exposing a composition containing the metal to purified to a composition described herein.

In some embodiments, the metal or metal salt is lithium. In other embodiments, the metal or metal salt is cobalt. In other embodiments, the metal or metal salt is nickel. In other embodiments, the metal or metal salt is lanthanum.

In still yet another aspect, the present disclosure provides methods of recycling the metal ions in a battery comprising contacting the components of the battery to a composition described herein.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description. Note that simply because a particular compound is ascribed to one particular generic formula doesn't mean that it cannot also belong to another generic formula.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 shows the polystyrene resin bearing dicyclohexylacetamide for LiPF₆ sequestration.

FIG. 2 shows the ATR-IR spectra of monomer 4 (top) and P2 (bottom).

FIGS. 3A-3C shows the determination of loading level. (a) Reaction scheme. (b) Concentration dependent conductivity of NHS in water. (c) Molar conductivity of NHS in water.

FIG. 4 shows NMR titration of L with LiPF₆ in CD₃CN (circle trace) and CD₃OD (square trace). Conditions: [L]=5 mM. Solutions of LiPF₆ were prepared freshly under N₂. At least 5 minutes were waited between measurements to ensure equilibrium is reached (FIG. 23). Error bars represent s.d., n=3. δ: chemical shift of proton a or a′; δ₀: initial chemical shift; δ_{Max}: chemical shift when [LiPF₆] is saturated. Detailed data fitting is provided in the Methods section below.

FIG. 5 shows Job's plot of of L+LiPF₆ in CD₃CN. Conditions: [L]+[LiPF₆]=10 mM at each molar variation. A time delay of at least 5 min was allowed between measurements to ensure equilibrium is reached (FIG. 23). δ: chemical shift of protons a or a′; δ₀: initial chemical shift; X_{L}: [L]/([L]+[LiPF₆]).

FIG. 6 shows the ESI-HRMS spectrum of L·LiPF₆.

FIG. 7 shows the NMR spectroscopic titration of L with NaPF₆ (circle trace) and KPF₆ (square trace) in CD₃CN. Conditions: [L]=0.1 mM. A time delay of at least 5 min was allowed between measurements to ensure equilibrium is reached (FIG. 23). Error bars represent s.d., n =3. δ: chemical shift of protons a or a′; δ₀: initial chemical shift; δ_{Max}: chemical shift when [NaPF₆] or [KPF₆] is saturated. Fitting results: [NaPF₆]: R²=0.9899 K=74±2 M⁻¹; [KPF₆]: R²=0.9926 K=61±1 M⁻¹.

FIG. 8 shows the kinetics of LiPF₆ adsorption by P2. Q: capacity of P2. Insert: Time-dependent concentration change. Conditions: [LiPF₆]=1.5 mM; 5 mL of a LiPF₆ solution in acetonitrile was added to 6 mg of P2. Conductivity measurements were performed every hour and converted to the corresponding concentrations using calibration curves (cf. FIG. S12). Insert: Time-dependent increase in concentration. Conditions: 6 mg of P2·LiPF₆ was suspended in 6 mL of anhydrous methanol. All solutions were prepared fresh and under N₂. Error bars represent s.d., n=3.

FIG. 9 shows the SEM image of P2·LiPF₆.

FIG. 10 shows the EDX spectrum of P2·LiPF₆.

FIG. 11 shows the solid state ³¹P and ⁷Li NMR spectra of P2·LiPF₆.

FIG. 12 shows the ATR-IR spectra of LiPF₆ (top) and P2·LiPF₆ (bottom).

FIG. 13 shows the ³¹P, ¹⁹F, and ⁷Li NMR spectra of the LiPF₆ presumed to be released in MeOH. A coaxial aqueous KF sample was used as an external reference for the ¹⁹F NMR spectral studies.

FIG. 14 shows the ATR-IR spectra of P2·LiPF₆ (top) and regenerated P2 (bottom).

FIG. 15 shows XPS analysis of P2·LiPF₆ (bottom traces) and P2 (top traces).

FIGS. 16A & 16B show plots of solution concentrations derived from conductivity measurements vs. cycle number for catch and release studies of LiPF₆ uptake by (a) P2 and (b) P3 and subsequent release. For the capture, 10 mg samples of P2 or P3 were added to 5 mL of a 3.0 mM solution. The resulting salt-containing forms, designated as P2·LiPF₆ and P3·LiPF₆, respectively, were then suspended in anhydrous methanol. All solutions were prepared fresh and under N₂. The resin was washed thoroughly with acetonitrile and methanol until conductivity readings reached baseline levels between each cycle of catch and release. An equilibrium time of 12 h was used for each capture and release stage.

FIGS. 17A & 17B show calibration curves of LiPF₆ concentration determined by conductivity measurements in (a) acetonitrile and (b) MeOH. All solutions were prepared fresh and under N₂. Error bars represent s.d., n=3. Fitting results: ACN: R²=0.9965 κ=148.38 c+2.93; MeOH: R²=0.9913 κ=95.96 c+2.85.

FIG. 18 shows ¹⁹F qNMR spectra of (a) degraded and (b) K₂CO_{3(g)} neutralized samples. A coaxial sample of LiTFSI dissolved in D₂O was used as the reference at −80.26 ppm.

FIGS. 19A & 19B show recovery of LiPF₆ from degraded electrolyte. (a) Capacities at various stages of degradation. (b) ³¹P, ¹⁹F, and ⁷Li NMR spectra of recovered LiPF₆ in CD₃CN. ref: external reference using battery grade lithium bis(trifluoromethanesulfonyl)imide (LiTFSI) in D₂O. Error bars represent s.d., n=3. Capacities were calculated according to Q=V(Δc)/m, where V is the volume of the solution, Δc is the concentration change, m is the weight of the resin.

FIG. 20 shows the ¹⁹F qNMR spectra of LiPF₆ in ACN. A coaxial sample of LiTFSI dissolved in D₂O was used as the reference at −80.26 ppm.

FIG. 21 shows the cost analysis of crown-ether functionalized polystyrene resin.

FIG. 22 shows the cost analysis of P2.

FIG. 23 shows time-dependent chemical shift changes. Conditions: Conditions: [L]=5 mM, [LiPF₆]=5 mM in CD₃CN. Solutions of LiPF₆ were prepared fresh under N₂. δ: chemical shift of protons a or a′.

FIG. 24 is an illustration of a receptor in different metal complexes. In aprotic solvents, the receptor binds to the metal complex. Introduction of protic solvent results in the release of the complex by the receptor.

FIG. 25 shows four metal complex receptors for use in the separation of an LiPF₆+LiTFSI mixture.

FIG. 26 shows a receptor that has been used to bind lanthanum and lutetium complexes.

### DESCRIPTION OF ILLUSTRATIVE EMBODIMENTS

The present disclosure provides functionalized resins that comprise a support and a metal chelating unit. The chelating units used on the support may further comprise one or more different chelating units. These chelating units may show selectivity or an improved binding to one or more metals, particular metal ions, over other similar metal ions. For example, the chelating unit may show improved selectivity for lithium compared to other alkali metals such as sodium, potassium or similar metals like calcium or magnesium. The chelating unit may contain two or more oxygen-based chelation points similar to a crown ether. These oxygen-based chelation points may be either an ether or a carbonyl from an amide, an ester, or a carboxylic acid.

Similarly, the chelating units may be covalently linked to one or more support that allows for the easy separation of the chelating unit from a solution. The support may be a hydrophobic resin that is resistant to degradation in organic solvents. For example, the support may be a resin, a polymer, or a hydrophobic surface such as the inner cavity of a device. These supports may be comprise one or more reactive functional groups, which may be used to join the chelating unit to the support. These functional or joining groups may include an amine, an azide, a carbon-carbon triple bond, a carboxylic acid, or a hydroxy group. Once joined, the support may form a heterogenous mixture with the support and the affixed chelating groups remaining undissolved in the solvent.

The present disclosure also provides methods of using these functionalized supports to obtain a metal sample. In particular, the metal samples obtained have purity of greater than 90% of the desired metal including achieving samples that are greater than 99% pure. These methods utilize the change in polarity of solvents to selectively bind and release the metal ions. First, the binding occurs in an aprotic solvent and then upon exposure to a protic solvent the metal or metal salt is released from the chelating unit. This method avoids the need to utilize supercritical CO₂ and other harsh conditions that are normally used in lithium recovery. The presently disclosed methods may be carried out at both atmospheric pressure and room temperature.

These and more advantages will be discussed in more detail below.

### A. Functionalized Supports of the Present Disclosure

The functionalized supports or functionalized resins of the present disclosure are shown, for example, above, in the summary section, the examples, and in the claims below. The compounds may be made using the synthetic methods outlined in the Examples section. These methods can be further modified and optimized using the principles and techniques of organic chemistry as applied by a person skilled in the art. Such principles and techniques are taught, for example, in Smith, March's Advanced Organic Chemistry: Reactions, Mechanisms, and Structure, (2013), which is incorporated by reference herein. In addition, the synthetic methods may be further modified and optimized for preparative, pilot- or large-scale production, either batch or continuous, using the principles and techniques of process chemistry as applied by a person skilled in the art. Such principles and techniques are taught, for example, in Anderson, Practical Process Research & Development—A Guide for Organic Chemists (2012), which is incorporated by reference herein.

The functionalized supports of the present disclosure may contain one or more asymmetrically-substituted carbon, nitrogen, sulfur, or phosphorus atom and may be isolated in optically active or racemic form. Thus, all chiral, diastereomeric, racemic form, epimeric form, and all geometric isomeric forms of a chemical formula are intended, unless the specific stereochemistry or isomeric form is specifically indicated. Compounds may occur as racemates and racemic mixtures, single enantiomers, diastereomeric mixtures and individual diastereomers. In some embodiments, a single diastereomer is obtained. The chiral centers of the compounds of the present invention can have the S or the R configuration. In some embodiments, the present compounds may contain two or more atoms which have a defined stereochemical orientation.

Chemical formulas used to represent the functionalized resins of the present disclosure will typically only show one of possibly several different tautomers. For example, many types of ketone groups are known to exist in equilibrium with corresponding enol groups. Similarly, many types of imine groups exist in equilibrium with enamine groups. Regardless of which tautomer is depicted for a given compound, and regardless of which one is most prevalent, all tautomers of a given chemical formula are intended.

In addition, atoms making up the compounds of the present disclosure are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C.

### B. Definitions

When used in the context of a chemical group: “hydrogen” means —H; “hydroxy” means —OH; “oxo” means ═O; “carbonyl” means —C(═O)—; “carboxy” means —C(═O)OH (also written as —COOH or —CO₂H); “halo” means independently —F, —Cl, —Br or —I; “amino” means —NH₂; “hydroxyamino” means —NHOH; “nitro” means —NO₂; imino means=NH; “cyano” means —CN; “isocyanyl” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; and “thio” means=S; “thiocarbonyl” means —C(═S)—; “sulfonyl” means —S(O)₂—; and “sulfinyl” means —S(O)—.

In the context of chemical formulas, the symbol “-” means a single bond, “═” means a double bond, and “≡” means triple bond. The symbol “ [symbol] ” represents an optional bond, which if present is either single or double. The symbol “ [symbol] ” represents a single bond or a double bond. Thus, the formula

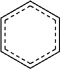

covers, for example,

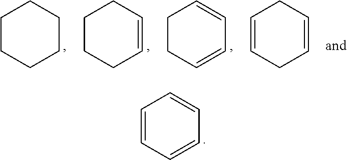

And it is understood that no one such ring atom forms part of more than one double bond. Furthermore, it is noted that the covalent bond symbol “-”, when connecting one or two stereogenic atoms, does not indicate any preferred stereochemistry. Instead, it covers all stereoisomers as well as mixtures thereof. The symbol “ [symbol] ”, when drawn perpendicularly across a bond (e.g.,

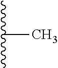

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means i single bond where the geometry around a double bond (e.g., either E or Z) is undefined. Both options, as well as combinations thereof are therefore intended. Any undefined valency on an atom of a structure shown in this application implicitly represents a hydrogen atom bonded to that atom. A bold dot on a carbon atom indicates that the hydrogen attached to that carbon is oriented out of the plane of the paper.

When a variable is depicted as a “floating group” on a ring system, for example, the group “R” in the formula:

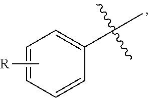

then the variable may replace any hydrogen atom attached to any of the ring atoms, including a depicted, implied, or expressly defined hydrogen, so long as a stable structure is formed. When a variable is depicted as a “floating group” on a fused ring system, as for example the group “R” in the formula:

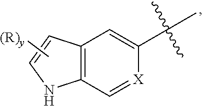

then the variable may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the R enclosed in parentheses, represents a numeric variable. Unless specified otherwise, this variable can be 0, 1, 2, or any integer greater than 2, only limited by the maximum number of replaceable hydrogen atoms of the ring or ring system.

For the chemical groups and compound classes, the number of carbon atoms in the group or class is as indicated as follows: “Cn” or “C=n” defines the exact number (n) of carbon atoms in the group/class. “C≤n” defines the maximum number (n) of carbon atoms that can be in the group/class, with the minimum number as small as possible for the group/class in question. For example, it is understood that the minimum number of carbon atoms in the groups “alkyl_{(C≤8)}”, “alkanediyl_{(C≤8)}”, “heteroaryl_{(C≤8)}”, and “acyl_{(C≤8)}” is one, the minimum number of carbon atoms in the groups “alkenyl_{(C≤8)}”, “alkynyl_{(C≤8)}”, and “heterocycloalkyl_{(C≤8)}” is two, the minimum number of carbon atoms in the group “cycloalkyl_{(C≤8)}” is three, and the minimum number of carbon atoms in the groups “aryl_{(C≤8)}” and “arenediyl_{(C≤8)}” is six. “Cn-n′” defines both the minimum (n) and maximum number (n′) of carbon atoms in the group. Thus, “alkyl_{(C2-10)}” designates those alkyl groups having from 2 to 10 carbon atoms. These carbon number indicators may precede or follow the chemical groups or class it modifies and it may or may not be enclosed in parenthesis, without signifying any change in meaning. Thus, the terms “C₁₋₄-alkyl”, “C1-4-alkyl”, “alkyl_{(C1-4)},”, and “alkyl_{(C≤4)}” are all synonymous. Except as noted below, every carbon atom is counted to determine whether the group or compound falls with the specified number of carbon atoms. For example, the group dihexylamino is an example of a dialkylamino_{(C12)} group; however, it is not an example of a dialkylamino_{(C6)} group. Likewise, phenylethyl is an example of an aralkyl_{(C=8)} group. When any of the chemical groups or compound classes defined herein is modified by the term “substituted”, any carbon atom in the moiety replacing the hydrogen atom is not counted. Thus methoxyhexyl, which has a total of seven carbon atoms, is an example of a substituted alkyl_{(C1-6)}. Unless specified otherwise, any chemical group or compound class listed in a claim set without a carbon atom limit has a carbon atom limit of less than or equal to twelve.

The term “saturated” when used to modify a compound or chemical group means the compound or chemical group has no carbon-carbon double and no carbon-carbon triple bonds, except as noted below. When the term is used to modify an atom, it means that the atom is not part of any double or triple bond. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded. When the term “saturated” is used to modify a solution of a substance, it means that no more of that substance can dissolve in that solution.

The term “aliphatic” signifies that the compound or chemical group so modified is an acyclic or cyclic, but non-aromatic compound or group. In aliphatic compounds/groups, the carbon atoms can be joined together in straight chains, branched chains, or non-aromatic rings (alicyclic). Aliphatic compounds/groups can be saturated, that is joined by single carbon-carbon bonds (alkanes/alkyl), or unsaturated, with one or more carbon-carbon double bonds (alkenes/alkenyl) or with one or more carbon-carbon triple bonds (alkynes/alkynyl).

The term “aromatic” signifies that the compound or chemical group so modified has a planar unsaturated ring of atoms with 4n+2 electrons in a fully conjugated cyclic π system.

An aromatic compound or chemical group may be depicted as a single resonance structure; however, depiction of one resonance structure is taken to also refer to any other resonance structure. For example:

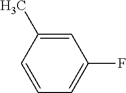

is also taken to refer to

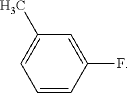

Aromatic compounds may also be depicted using a circle to represent the delocalized nature of the electrons in the fully conjugated cyclic π system, two non-limiting examples of which are shown below: The term “alkyl” refers to a monovalent saturated aliphatic group with a carbon atom as the point of attachment, a linear or branched acyclic structure, and no atoms other than carbon and hydrogen. The groups —CH₃ (Me), —CH₂CH₃ (Et), —CH₂CH₂CH₃ (n-Pr or propyl), —CH(CH₃)₂(i-Pr, ⁱPr or isopropyl), —CH₂CH₂CH₂CH₃ (n-Bu), —CH(CH₃)CH₂CH₃ (sec-butyl), —CH₂CH(CH₃)₂(isobutyl), —C(CH₃)₃(tert-butyl, t-butyl, t-Bu or ^{t}Bu), and —CH₂C(CH₃)₃(neo-pentyl) are non-limiting examples of alkyl groups. The term “alkanediyl” refers to a divalent saturated aliphatic group, with one or two saturated carbon atom(s) as the point(s) of attachment, a linear or branched acyclic structure, no carbon-carbon double or triple bonds, and no atoms other than carbon and hydrogen. The groups —CH₂— (methylene), —CH₂CH₂—, —CH₂C(CH₃)₂CH₂—, and —CH₂CH₂CH₂— are non-limiting examples of alkanediyl groups. The term “alkylidene” refers to the divalent group ═CRR′ in which R and R′ are independently hydrogen or alkyl. Non-limiting examples of alkylidene groups include: =CH₂, =CH(CH₂CH₃), and ═C(CH₃)₂. An “alkane” refers to the class of compounds having the formula H—R, wherein R is alkyl as this term is defined above.

The term “cycloalkyl” refers to a monovalent saturated aliphatic group with a carbon atom as the point of attachment, said carbon atom forming part of one or more non-aromatic ring structures, no carbon-carbon double or triple bonds, and no atoms other than carbon and hydrogen. If more than one ring is present, the rings may be fused, bridged, or spirocyclic.

Non-limiting examples include: —CH(CH₂)₂(cyclopropyl), cyclobutyl, cyclopentyl, or cyclohexyl (Cy). As used herein, the term does not preclude the presence of one or more alkyl groups (carbon number limitation permitting) attached to a carbon atom of the non-aromatic ring structure. The term “cycloalkanediyl” refers to a divalent saturated aliphatic group with two carbon atoms as points of attachment, no carbon-carbon double or triple bonds, and no atoms other than carbon and hydrogen. The group

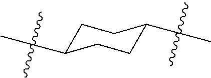 [SMILES: *C1CCC(*)CC1]

is a non-limiting example of cycloalkanediyl group. A “cycloalkane” refers to the class of compounds having the formula H—R, wherein R is cycloalkyl as this term is defined above.

The term “alkenyl” refers to a monovalent unsaturated aliphatic group with a carbon atom as the point of attachment, a linear or branched, acyclic structure, at least one nonaromatic carbon-carbon double bond, no carbon-carbon triple bonds, and no atoms other than carbon and hydrogen. Non-limiting examples include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” refers to a divalent unsaturated aliphatic group, with two carbon atoms as points of attachment, a linear or branched acyclic structure, at least one nonaromatic carbon-carbon double bond, no carbon-carbon triple bonds, and no atoms other than carbon and hydrogen. The groups —CH═CH—, —CH═C(CH₃)CH₂—, —CH═CHCH₂—, and —CH₂CH═CHCH₂— are non-limiting examples of alkenediyl groups. It is noted that while the alkenediyl group is aliphatic, once connected at both ends, this group is not precluded from forming part of an aromatic structure. The terms “alkene” and “olefin” are synonymous and refer to the class of compounds having the formula H—R, wherein R is alkenyl as this term is defined above. Similarly, the terms “terminal alkene” and “α-olefin” are synonymous and refer to an alkene having just one carbon-carbon double bond, wherein that bond is part of a vinyl group at an end of the molecule.

The term “alkynyl” refers to a monovalent unsaturated aliphatic group with a carbon atom as the point of attachment, a linear or branched acyclic structure, at least one carbon-carbon triple bond, and no atoms other than carbon and hydrogen. As used herein, the term alkynyl does not preclude the presence of one or more non-aromatic carbon-carbon double bonds. The groups —C≡CH, —C≡CCH₃, and —CH₂C≡CCH₃ are non-limiting examples of alkynyl groups. An “alkyne” refers to the class of compounds having the formula H—R, wherein R is alkynyl.

The term “aryl” refers to a monovalent unsaturated aromatic group with an aromatic carbon atom as the point of attachment, said carbon atom forming part of a one or more aromatic ring structures, each with six ring atoms that are all carbon, and wherein the group consists of no atoms other than carbon and hydrogen. If more than one ring is present, the rings may be fused or unfused. Unfused rings are connected with a covalent bond. As used herein, the term aryl does not preclude the presence of one or more alkyl groups (carbon number limitation permitting) attached to the first aromatic ring or any additional aromatic ring present. Non-limiting examples of aryl groups include phenyl (Ph), methylphenyl, (dimethyl)phenyl, —C₆H₄CH₂CH₃ (ethylphenyl), naphthyl, and a monovalent group derived from biphenyl (e.g., 4-phenylphenyl). The term “arenediyl” refers to a divalent aromatic group with two aromatic carbon atoms as points of attachment, said carbon atoms forming part of one or more six-membered aromatic ring structures, each with six ring atoms that are all carbon, and wherein the divalent group consists of no atoms other than carbon and hydrogen. As used herein, the term arenediyl does not preclude the presence of one or more alkyl groups (carbon number limitation permitting) attached to the first aromatic ring or any additional aromatic ring present. If more than one ring is present, the rings may be fused or unfused. Unfused rings are connected with a covalent bond. Non-limiting examples of arenediyl groups include:

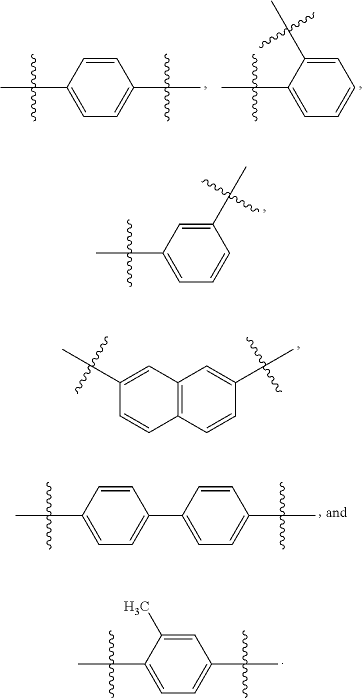

An “arene” refers to the class of compounds having the formula H—R, wherein R is aryl as that term is defined above. Benzene and toluene are non-limiting examples of arenes.

The term “aralkyl” refers to the monovalent group -alkanediyl-aryl, in which the terms alkanediyl and aryl are each used in a manner consistent with the definitions provided above. Non-limiting examples are: phenylmethyl (benzyl, Bn) and 2-phenyl-ethyl.

The term “heteroaryl” refers to a monovalent aromatic group with an aromatic carbon atom or nitrogen atom as the point of attachment, said carbon atom or nitrogen atom forming part of one or more aromatic ring structures, each with three to eight ring atoms, wherein at least one of the ring atoms of the aromatic ring structure(s) is nitrogen, oxygen or sulfur, and wherein the heteroaryl group consists of no atoms other than carbon, hydrogen, aromatic nitrogen, aromatic oxygen and aromatic sulfur. If more than one ring is present, the rings are fused; however, the term heteroaryl does not preclude the presence of one or more alkyl or aryl groups (carbon number limitation permitting) attached to one or more ring atoms. Non-limiting examples of heteroaryl groups include benzoxazolyl, benzimidazolyl, furanyl, imidazolyl (Im), indolyl, indazolyl, isoxazolyl, methylpyridinyl, oxazolyl, oxadiazolyl, phenylpyridinyl, pyridinyl (pyridyl), pyrrolyl, pyrimidinyl, pyrazinyl, quinolyl, quinazolyl, quinoxalinyl, triazinyl, tetrazolyl, thiazolyl, thienyl, and triazolyl. The term “N-heteroaryl” refers to a heteroaryl group with a nitrogen atom as the point of attachment. The term “heteroarenediyl” refers to a divalent aromatic group, with two aromatic carbon atoms, two aromatic nitrogen atoms, or one aromatic carbon atom and one aromatic nitrogen atom as the two points of attachment, said atoms forming part of one or more aromatic ring structures, each with three to eight ring atoms, wherein at least one of the ring atoms of the aromatic ring structure(s) is nitrogen, oxygen or sulfur, and wherein the divalent group consists of no atoms other than carbon, hydrogen, aromatic nitrogen, aromatic oxygen and aromatic sulfur. If more than one ring is present, the rings are fused; however, the term heteroarenediyl does not preclude the presence of one or more alkyl or aryl groups (carbon number limitation permitting) attached to one or more ring atoms. Non-limiting examples of heteroarenediyl groups include:

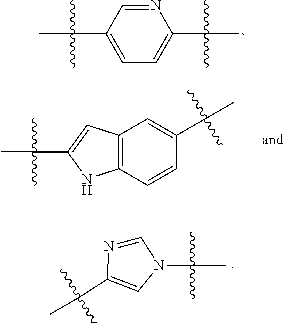 [SMILES: *c1ccc(*)nc1 ; *c1ccc2[nH]c(*)cc2c1 ; *c1cn(*)cn1]

A “heteroarene” refers to the class of compounds having the formula H—R, wherein R is heteroaryl. Pyridine and quinoline are non-limiting examples of heteroarenes.

The term “heterocycloalkyl” refers to a monovalent non-aromatic group with a carbon atom or nitrogen atom as the point of attachment, said carbon atom or nitrogen atom forming part of one or more non-aromatic ring structures, each with three to eight ring atoms, wherein at least one of the ring atoms of the non-aromatic ring structure(s) is nitrogen, oxygen or sulfur, and wherein the heterocycloalkyl group consists of no atoms other than carbon, hydrogen, nitrogen, oxygen and sulfur. If more than one ring is present, the rings may be fused, bridged, or spirocyclic. As used herein, the term does not preclude the presence of one or more alkyl groups (carbon number limitation permitting) attached to one or more ring atoms. Also, the term does not preclude the presence of one or more double bonds in the ring or ring system, provided that the resulting group remains non-aromatic. Non-limiting examples of heterocycloalkyl groups include aziridinyl, azetidinyl, pyrrolidinyl, piperidinyl, piperazinyl, morpholinyl, thiomorpholinyl, tetrahydrofuranyl, tetrahydrothiofuranyl, tetrahydropyranyl, pyranyl, oxiranyl, and oxetanyl. The term “N-heterocycloalkyl” refers to a heterocycloalkyl group with a nitrogen atom as the point of attachment. N-pyrrolidinyl is an example of such a group. The term “heterocycloalkanediyl” refers to a divalent cyclic group, with two carbon atoms, two nitrogen atoms, or one carbon atom and one nitrogen atom as the two points of attachment, said atoms forming part of one or more ring structure(s) wherein at least one of the ring atoms of the non-aromatic ring structure(s) is nitrogen, oxygen or sulfur, and wherein the divalent group consists of no atoms other than carbon, hydrogen, nitrogen, oxygen and sulfur. If more than one ring is present, the rings may be fused, bridged, or spirocyclic. As used herein, the term heterocycloalkanediyl does not preclude the presence of one or more alkyl groups (carbon number limitation permitting) attached to one or more ring atoms. Also, the term does not preclude the presence of one or more double bonds in the ring or ring system, provided that the resulting group remains non-aromatic. Non-limiting examples of heterocycloalkanediyl groups include:

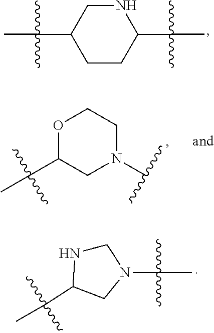

The term “heterocycloalkane” refers to the class of compounds having the formula H—R, wherein R is heterocycloalkyl as that term is defined above.

The term “acyl” refers to the group —C(O)R, in which R is a hydrogen, alkyl, cycloalkyl, or aryl as those terms are defined above. The groups, —CHO, —C(O)CH₃ (acetyl, Ac), —C(O)CH₂CH₃, —C(O)CH(CH₃)₂, —C(O)CH(CH₂)₂, —C(O)C₆H₅, and —C(O)C₆H₄CH₃ are non-limiting examples of acyl groups. A “thioacyl” is defined in an analogous manner, except that the oxygen atom of the group —C(O)R has been replaced with a sulfur atom, —C(S)R. The term “aldehyde” corresponds to an alkyl group, as defined above, attached to a —CHO group.

The term “alkoxy” refers to the group —OR, in which R is an alkyl, as that term is defined above. Non-limiting examples include: —OCH₃ (methoxy), —OCH₂CH₃ (ethoxy), —OCH₂CH₂CH₃, —OCH(CH₃)₂(isopropoxy), or —OC(CH₃)₃(tert-butoxy). The terms “cycloalkoxy”, “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is cycloalkyl, alkenyl, alkynyl, aryl, aralkyl, heteroaryl, heterocycloalkyl, and acyl, respectively. The term “alkylthio” and “acylthio” refers to the group —SR, in which R is an alkyl and acyl, respectively. The term “alcohol” corresponds to an alkane, as defined above, wherein at least one of the hydrogen atoms has been replaced with ahydroxy group. The term “ether” corresponds to an alkane, as defined above, wherein at least one of the hydrogen atoms has been replaced with an alkoxy group.

The term “alkylamino” refers to the group —NHR, in which R is an alkyl, as that term is defined above. Non-limiting examples include: —NHCH₃ and —NHCH₂CH₃. The term “dialkylamino” refers to the group —NRR′, in which R and R′ can be the same or different alkyl groups. Non-limiting examples of dialkylamino groups include: —N(CH₃)₂ and —N(CH₃)(CH₂CH₃). The term “amido” (acylamino), when used without the “substituted” modifier, refers to the group —NHR, in which R is acyl, as that term is defined above. A non-limiting example of an amido group is —NHC(O)CH₃.

When a chemical group is used with the “substituted” modifier, one or more hydrogen atom has been replaced, independently at each instance, by —OH, —F, —Cl, —Br, —I, —NH₂, —NO₂, —CO₂H, —CO₂CH₃, —CO₂CH₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. For example, the following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂Cl. The term “haloalkyl” is a subset of substituted alkyl, in which the hydrogen atom replacement is limited to halo (i.e. —F, —Cl, —Br, or —I) such that no other atoms aside from carbon, hydrogen and halogen are present. The group, —CH₂Cl is a non-limiting example of a haloalkyl. The term “fluoroalkyl” is a subset of substituted alkyl, in which the hydrogen atom replacement is limited to fluoro such that no other atoms aside from carbon, hydrogen and fluorine are present. The groups —CH₂F, —CF₃, and —CH₂CF₃ are non-limiting examples of fluoroalkyl groups. Non-limiting examples of substituted aralkyls are: (3-chlorophenyl)-methyl, and 2-chloro-2-phenyl-eth-1-yl. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups. The groups —NHC(O)OCH₃ and —NHC(O)NHCH₃ are non-limiting examples of substituted amido groups.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects or patients.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “effective,” as that term is used in the specification and/or claims, means adequate to accomplish a desired, expected, or intended result.

The term “hydrate” when used as a modifier to a compound means that the compound has less than one (e.g., hemihydrate), one (e.g., monohydrate), or more than one (e.g., dihydrate) water molecules associated with each compound molecule, such as in solid forms of the compound.

An “isomer” of a first compound is a separate compound in which each molecule contains the same constituent atoms as the first compound, but where the configuration of those atoms in three dimensions differs.

A “stereoisomer” or “optical isomer” is an isomer of a given compound in which the same atoms are bonded to the same other atoms, but where the configuration of those atoms in three dimensions differs. “Enantiomers” are stereoisomers of a given compound that are mirror images of each other, like left and right hands. “Diastereomers” are stereoisomers of a given compound that are not enantiomers. Chiral molecules contain a chiral center, also referred to as a stereocenter or stereogenic center, which is any point, though not necessarily an atom, in a molecule bearing groups such that an interchanging of any two groups leads to a stereoisomer. In organic compounds, the chiral center is typically a carbon, phosphorus or sulfur atom, though it is also possible for other atoms to be stereocenters in organic and inorganic compounds. A molecule can have multiple stereocenters, giving it many stereoisomers. In compounds whose stereoisomerism is due to tetrahedral stereogenic centers (e.g., tetrahedral carbon), the total number of hypothetically possible stereoisomers will not exceed 2″, where n is the number of tetrahedral stereocenters. Molecules with symmetry frequently have fewer than the maximum possible number of stereoisomers. A 50:50 mixture of enantiomers is referred to as a racemic mixture. Alternatively, a mixture of enantiomers can be enantiomerically enriched so that one enantiomer is present in an amount greater than 50%. Typically, enantiomers and/or diastereomers can be resolved or separated using techniques known in the art. It is contemplated that that for any stereocenter or axis of chirality for which stereochemistry has not been defined, that stereocenter or axis of chirality can be present in its R form, S form, or as a mixture of the R and S forms, including racemic and non-racemic mixtures. As used herein, the phrase “substantially free from other stereoisomers” means that the composition contains ≤15%, more preferably ≤10%, even more preferably ≤5%, or most preferably ≤1% of another stereoisomer(s).

A “recycling composition” is a composition comprising one or more metal or metal salts of interest, wherein the composition arises from a composition that has completely its natural life cycle. In particular, the recycling composition is a composition prepared from a battery or a battery powered device, such as a laptop, a phone, a tablet, or a television. The recycling composition may contain one or more metal or metal salts of interest with one or more metal or metal salts other than those of interest. The metal or metal salt of interest may be a monovalent, a divalent, or a trivalent metal salt. The recycling composition may be a device or battery that has been dissolved into a solution with multiple different ions.

A “repeat unit”, also referred to as a “subunit”, is the simplest structural entity of certain materials, for example, frameworks and/or polymers, whether organic, inorganic or metal-organic. In the case of a polymer chain, repeat units are linked together successively along the chain, like the beads of a necklace. For example, in polyethylene, —[—CH₂CH₂-]ₙ—, the repeat unit is —CH₂CH₂—. The subscript “n” denotes the degree of polymerization, that is, the number of repeat units linked together. When the value for “n” is left undefined or where “n” is absent, it simply designates repetition of the formula within the brackets as well as the polymeric nature of the material. The concept of a repeat unit applies equally to where the connectivity between the repeat units extends three dimensionally, such as in metal organic frameworks, modified polymers, thermosetting polymers, etc.

The above definitions supersede any conflicting definition in any reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

### C. Supports Used Herein

The present disclosure relates to a chelating unit that may be used in conjunction with one or more polymer. These chelating units may be affixed to a polymer backbone such as a polystyrene, polyvinyl, polyacrylate, polymethacrylate, polyethylene, polypropylene, polyethylene glycol, polypropylene glycol, or a polylactone. These polymers may be synthesized with a reactive or joining group that is then reacted with the chelating group. In other aspects, the chelating group is attached to the monomers before polymerization.

The present disclosure also contemplates the use of supports. In particular, supports that remain heterogenous with the starting solution may be used. A variety of solid supports may be used in the present invention. Suitable solid supports include silica-based supports such as glass fiber, or other materials such as cellulose, cellulose acetate, nitrocellulose, nylon, polyester, polyethersulfone, polyolefin, polyvinylidene fluoride, and combinations thereof. The solid support may be encased or immobilized in a vessel to enable plug-flow or continuous-flow purification methods. Alternatively, the material of the solid support may be packed so as to create a free-standing solid support such as a membrane, disk, or cylinder that may be immobilized or encased in a suitable vessel, such as a tube or plate. In one embodiment, the solid support may be fibrous or particulate to allow optimal contact with the biological material. The size of the solid support suitable for use in the methods described herein may vary according to the volume of the material. For example, glass fiber membranes may be cut to different sizes, in order to allow for the binding, purification and elution of different quantities of the desired metal.

The shape of the solid support suitable for use in the methods described herein may be, for example, a sheet, a precut disk, cylinder, single fiber, or a solid support composed of particulates. The material of the solid support may be packed so as to create a free-standing solid support such as a membrane, disk, or cylinder that may be immobilized or encased in a suitable vessel. If necessary, the solid support is contained in an appropriate vessel, e.g., a paper form (such as a Guthrie card), a microcentrifuge tube, a spin tube, a 96-well plate, a chamber, or a cartridge. If the solid support comprises fibers, it may be encased in a suitable vessel so as to pack the fibers appropriately, allow for metal binding, and the washing away of contaminants.

### D. Lithium Extractions

The present disclosure relates to methods of using the functionalized supports to separate or purify a metal or metal salt from a mixture of the metal or metal salt and at least one other metal or metal salt. These methods may be utilized to separate ions of the metal. These methods may be used to separate metal salts of any oxidation state or charge. In particular, the methods may be used to recycle one or more metals or metal salts from a starting composition that contains several other metals or metal salts, such as two, three, four, five, six, seven, eight, or more metals or metal salts. In particular, the methods described herein may be used to purify lithium such as lithium hexafluorophosphate or lithium bis(trifluoromethanesulfonyl)imide. In particular, the methods may also be used to purify transition metals or transition metal salts such as cobalt and nickel. In other aspects, the methods can be used to purify actinides or lanthanides such as lanthanum. In particular, these metals or metal salts may be presented as ions with weakly coordinating anions. Weakly coordinating anions only form a weak ionic bond to the metal cation. Some non-limiting examples include imide anions or polyfluoride anions such as hexafluorophosphate, hexafluoroarsenate, hexafluoroantimonate, or hexafluorobismuthate.

In some aspects, the present methods relate to the use of aprotic solvents, such as organic aprotic solvents. Aprotic solvents generally refers to a solvent without any functional groups that act as a hydrogen bond donor such as a hydroxy or amine group. There are exceptions to this generally rule. While on the other hand, a protic solvent is a solvent with at least one hydrogen that can form hydrogen bonds. Some non-limiting examples of aprotic solvents include dichloromethane, tetrahydrofuran, ethyl acetate, acetonitrile, dimethylformamide, dimethyl sulfoxide, acetone, or hexamethylphosphoric triamide. On the other hand, protic solvents include methanol, ethanol, isopropanol, t-butanol, acetic acid, ethanolamine, ethylenediamine, or if not describing organic solvents, water. Furthermore, if a protic solvent is used, the solvent may be wet or contain a certain amount of water. The protic solvent may contain at least 10%, 9%, 8%, 7%, 6%, 5%, 4%, 3%, 2%, or 1% water.

The methods used herein may be used to obtain a metal sample that comprises at least 80%, at least 90%, at least 92.5%, at least 95%, at least 96%, at least 97%, at least 98%, at least 99%, or at least 99.5% of the desired metal or metal salt.

Furthermore, the present methods may be used under normal atmospheric conditions. The methods do not require increased pressure or cold temperatures in order to achieve the desired purity of the metal to be purified. The method may be carried out at a temperature from about −80° C., −70° C., −60° C., −50° C., −40° C., −30° C., −20° C., −10° C., 0° C., 10° C., 20° C., 30° C., 40° C., 50° C., 60° C., 70° C., to about 80° C., or any range derivable therein. Similarly, the methods may be used at standard atmospheric pressure but similarly may be run at either high or low pressure. For example, the methods may be carried out at a pressure from about 0.1 atm, 0.2 atm, 0.3 atm, 0.4 atm, 0.5 atm, 0.6 atm, 0.7 atm, 0.8 atm, 0.9 atm, 1 atm, 2 atm, 3 atm, 4 atm, 5 atm, 6 atm, 7 atm, 8 atm, 9 atm, to about 10 atm, or any range derivable therein.

### E. Embodiments of the Disclosure

1. A method of obtaining a purified metal or a metal salt of interest from a composition comprising at least a metal or metal salt to be purified, the method comprising:
   (A) contacting the composition with a metal selective chelating agent in the presence of an aprotic solvent to form a metalated metal selective chelating agent; and
   (B) exposing the metalated metal selective chelating agent to a protic solvent to form a purified metal sample.
2. The method of embodiment 1, wherein the composition is a recycling composition.
3. The method of embodiment 2, wherein the composition is electronic waste.
4. The method of embodiment 3, wherein the electronic waste is waste from a battery.
5. The method of embodiment 3, wherein the electronic waste is waste from a battery powered device.
6. The method of embodiment 5, wherein the battery powered device is a laptop, tablet, phone, or television.
7. The method according to any one of embodiments 1-6, wherein the composition comprises two or more additional metals or metal salts other than the metal or metal salt of interest.
8. The method according to any one of embodiments 1-7, wherein the composition comprises two, three, four, five, or six additional metals or metal salts other than the metal or metal salt of interest.
9. The method according to any one of embodiments 1-8, wherein the metal or metal salt of interest is a monovalent metal salt, a divalent metal salt, or a trivalent metal salt.
10. The method according to any one of embodiments 1-9, wherein the monovalent metal salt is a monovalent alkali metal salt.
11. The method of embodiment 10, wherein the monovalent alkali metal salt is a lithium salt.
12. The method according to any one of embodiments 1-9, wherein the metal or metal salt of interest is a divalent metal salt.
13. The method of embodiment 12, wherein the divalent metal salt is a transition metal salt.
14. The method of either embodiment 12 or embodiment 13, wherein the divalent metal salt is a nickel salt.
15. The method of either embodiment 12 or embodiment 13, wherein the divalent metal salt is a cobalt salt.
16. The method according to any one of embodiments 1-8, wherein the metal or metal salt of interest is an actinide or a lanthanide.
17. The method of embodiment 16, wherein the metal to be purified is a lanthanide salt.
18. The method of embodiment 17, wherein the metal to be purified is a trivalent lanthanide salt.
19. The method according to any one of embodiments 1-18, wherein the metal or metal salt of interest is a salt with a counter anion.
20. The method of embodiment 19, wherein the counter anion is a weakly coordinating anion.
21. The method of embodiment 20, wherein the weakly coordinating anion is bis(trifluoromethanesulfonyl)imide or hexafluorophosphate.
22. The method of embodiment 21, wherein the weakly coordinating anion is hexafluorophosphate.
23. The method of embodiment 21, wherein the weakly coordinating anion is bis(trifluoromethanesulfonyl)imide.
24. The method of embodiment 19, wherein the counter anion is a halide.
25. The method of embodiment 24, wherein the halide is a chloride.
26. The method of embodiment 19, wherein the counter anion is a nitrate.
27. The method according to any one of embodiments 1-26, wherein the composition is from a battery.
28. The method of embodiment 27, wherein the battery is a lithium-ion battery.
29. The method according to any one of embodiments 1-28, wherein the metal selective chelating agent comprises a chelating unit of the formula:

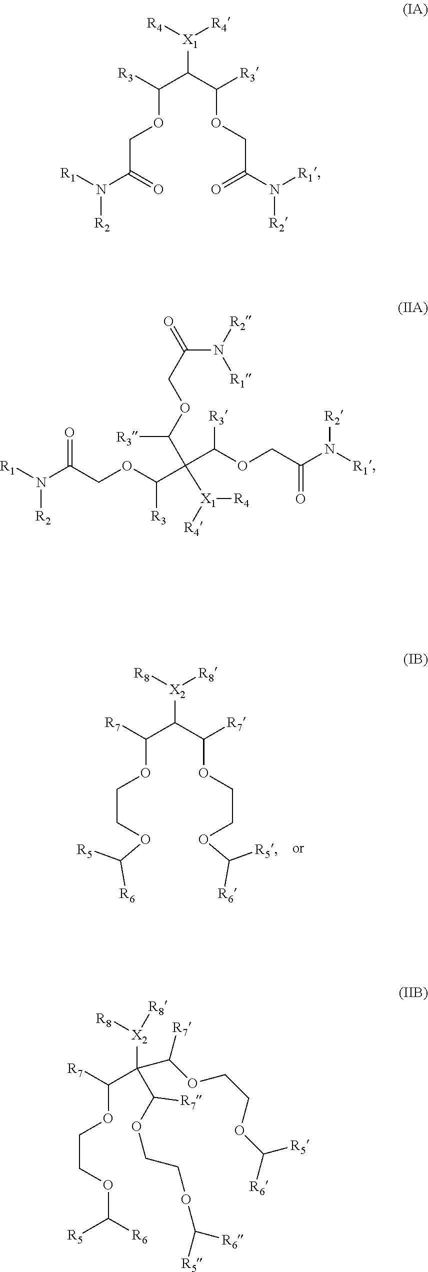

wherein:
   R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
   R₃, R₃′, R₃″, R₇, R₇′, and R₇″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
   R₄, R₄′, R₈, and R₈′ are hydrogen, a bond to a support, or taken together as defined above; and
X₁ and X₂ are each independently O or N.
30. The method according to any one of embodiments 1-29, wherein the metal selective chelating agent comprises a chelating unit of the formula:

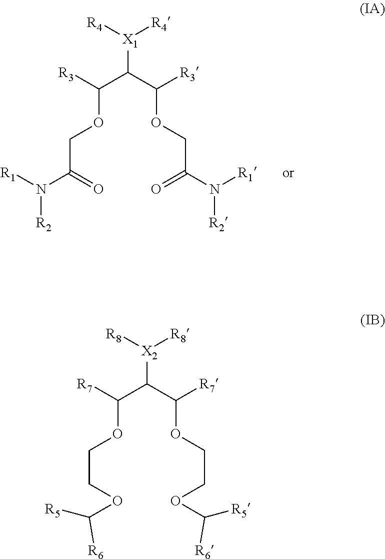

wherein:
   R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
   R₃, R₃′, R₇, and R₂′ are each independently hydrogen or R₃ and R₄, R₃′ and R₄′, R₇ and R₈, or R₇′ and R₈′ are joined together to form a 3-8 membered cycloalkane ring or a 3-8 membered heterocycloalkane ring;
   R₄, R₄′, R₈, and R₈′ are hydrogen, a bond to a support, or taken together as defined above; and
X₁ and X₂ are each independently O or N.
31. The method of embodiment 30, wherein the chelating unit is further defined as:

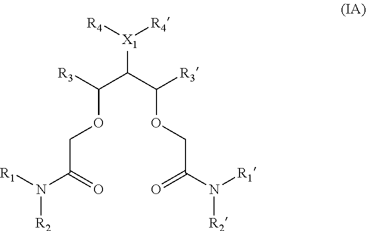

wherein:
   R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
   R₃ and R₃′ are each independently hydrogen or R₃ and R₄ or R₃′ and R₄′ are joined together to form a 3-8 membered cycloalkane ring or a 3-8 membered heterocycloalkane ring;
   R₄ and R₄′ are hydrogen, a bond to a support, or taken together as defined above; and
   X₁ is O or N.
32. The method of embodiment 29, wherein the chelating unit is further defined as:

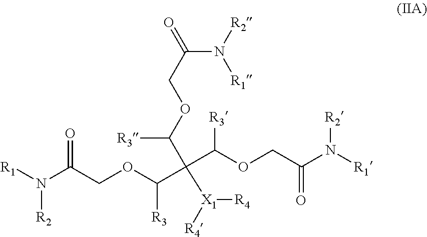

wherein:
   R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups;
   R₃, R₃′, and R₃″ are each independently hydrogen or R₃ and R₄, R₃′ and R₄′, and R₃″ and R₄″ are joined together to form a 3-8 membered cycloalkane ring or a 3-8 membered heterocycloalkane ring;
   R₄ and R₄′ are hydrogen, a bond to a support, or taken together as defined above; and
   X₁ and X₂ are each independently O or N.
33. The method of either embodiment 30 or embodiment 31, wherein the chelating unit is further defined as:

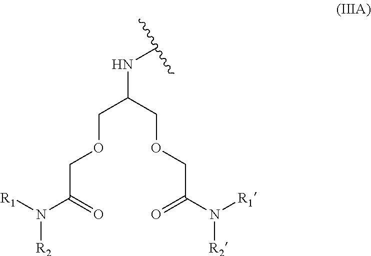

wherein:
   R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
   the open valence is connected to a support.
34. The method of either embodiment 29 or embodiment 32, wherein the chelating unit is further defined as:

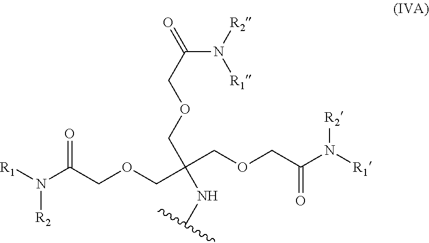

wherein:
   R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and
   the open valance is connected to a support.
35. The method of embodiment 30, wherein the chelating unit is further defined as:

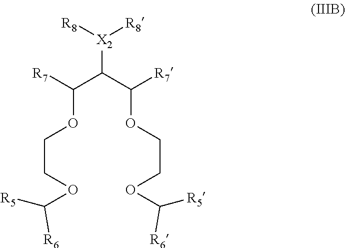

wherein:
   R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
   R₇ and R₇′ are each independently hydrogen or R₇ and R₈ or R₇′ and R₈′ are joined together to form a 3-8 membered cycloalkane ring or a 3-8 membered heterocycloalkane ring;
   R₈ and R₈′ are hydrogen, a connection to a resin or polymer, or taken together as defined above; and
   X₂ is O or N.
36. The method of embodiment 29 further defined as:

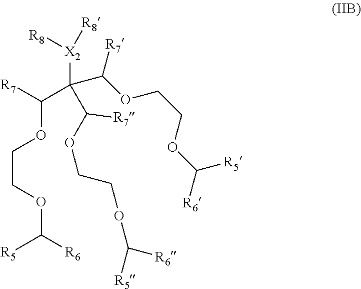

wherein:
   R₅, R₅′, R₅″, R₆, R₆, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
   R₇, R₇′, and R₇″ are each independently hydrogen or R₇ and R₈, R₇′ and R₈′, or R₇″ and R₈″ are joined together to form a 3-8 membered cycloalkane ring or a 3-8 membered heterocycloalkane ring;
   R₈ and R₈′ are hydrogen, a bond to a support, or taken together as defined above; and
   X₁ and X₂ are each independently O or N.
37. The method of either embodiment 30 or embodiment 35 further defined as:

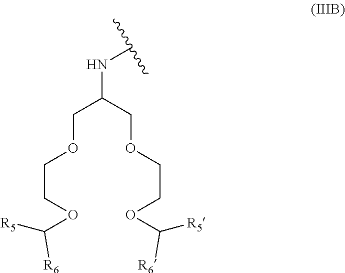

wherein:
   R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups; and
   the open valence is connected to a support.
38. The method of embodiment 36 further defined as:

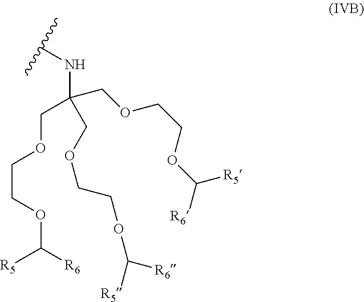

wherein:
   R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups; and
   the open valance is connected to a support.
39. The method according to any one of embodiments 29-34, wherein R₁ is cycloalkyl_{(C≤12)} or substituted cycloalkyl_{(C≤12)}.
40. The method of embodiment 39, wherein R₁ is cycloalkyl_{(C≤12)}.
41. The method of either embodiment 39 or embodiment 40, wherein R₁ is cyclohexyl.
42. The method according to any one of embodiments 29-34 and 39-41, wherein R₁′ is cycloalkyl_{(C≤12)} or substituted cycloalkyl_{(C≤12)}.
43. The method of embodiment 42, wherein R₁′ is cycloalkyl_{(C≤12)}.
44. The method of either embodiment 42 or embodiment 43, wherein R₁′ is cyclohexyl.
45. The method according to any one of embodiments 29-34 and 39-44, wherein R₁″ is cycloalkyl_{(C≤12)} or substituted cycloalkyl_{(C≤12)}.
46. The method of embodiment 45, wherein R₁″ is cycloalkyl_{(C≤12)}.
47. The method of either embodiment 42 or embodiment 43, wherein R₁′ is cyclohexyl.
48. The method according to any one of embodiments 29-34 and 39-47, wherein R₂ is cycloalkyl_{(C≤12)} or substituted cycloalkyl_{(C≤12)}.
49. The method of embodiment 48, wherein R₂ is cycloalkyl_{(C≤12)}.
50. The method of either embodiment 48 or embodiment 49, wherein R₂ is cyclohexyl.
51. The method according to any one of embodiments 29-34 and 39-50, wherein R₂′ is cycloalkyl_{(C≤12)} or substituted cycloalkyl_{(C≤12)}.
52. The method of embodiment 51, wherein R₂′ is cycloalkyl_{(C≤12)}.
53. The method of either embodiment 51 or embodiment 52, wherein R₂′ is cyclohexyl.
54. The method according to any one of embodiments 29-34 and 39-53, wherein R₂″ is cycloalkyl_{(C≤12)} or substituted cycloalkylh_{(C≤12)}.
55. The method of embodiment 54, wherein R₂″ is cycloalkyl_{(C≤12)}.
56. The method of either embodiment 54 or embodiment 55, wherein R₂″ is cyclohexyl.
57. The method according to any one of embodiments 29, 30, and 35-38, wherein R₅ is cycloalkyl_{(C≤12)} or substituted cycloalkyl_{(C≤12)}.
58. The method of embodiment 57, wherein R₅ is cycloalkyl_{(C≤12)}.
59. The method of either embodiment 57 or embodiment 58, wherein R₅ is cyclohexyl.
60. The method according to any one of embodiments 30, 35-38, and 57-59, wherein R₅′ is cycloalkyl_{(C≤12)} or substituted cycloalkyl_{(C≤12)}.
61. The method of embodiment 60, wherein R₅′ is cycloalkyl_{(C≤12)}.
62. The method of either embodiment 60 or embodiment 61, wherein R₅′ is cyclohexyl.
63. The method according to any one of embodiments 30, 35-38, and 57-62, wherein R₅″ is cycloalkyl_{(C≤12)} or substituted cycloalkyl_{(C≤12)}.
64. The method of embodiment 63, wherein R₅″ is cycloalkyl_{(C≤12)}.
65. The method of either embodiment 64 or embodiment 65, wherein R₅″ is cyclohexyl.
66. The method according to any one of claims 30, 35-38, and 57-65, wherein R₆ is cycloalkyl_{(C≤12)} or substituted cycloalkyl_{(C≤12)}.
67. The method of embodiment 66, wherein R₆ is cycloalkyl_{(C≤12)}.
68. The method of either embodiment 66 or embodiment 67, wherein R₆ is cyclohexyl.
69. The method according to any one of embodiments 30, 35-38, and 57-68, wherein R₆′ is cycloalkyl_{(C≤12)} or substituted cycloalkyl_{(C≤12)}.
70. The method of embodiment 69, wherein R₆′ is cycloalkyl_{(C≤12)}.
71. The method of either embodiment 69 or embodiment 70, wherein R₆′ is cyclohexyl.
72. The method according to any one of embodiments 30, 35-38, and 57-68, wherein R₆″ is cycloalkyl_{(C≤12)} or substituted cycloalkyl_{(C≤12)}.
73. The method of embodiment 72, wherein R₆″ is cycloalkyl_{(C≤12)}.
74. The method of either embodiment 72 or embodiment 73, wherein R₆″ is cyclohexyl.
75. The method according to any one of embodiments 1-74, wherein the metal selective chelating agent further comprises a support.
76. The method of embodiment 75, wherein the support is a hydrophobic support.
77. The method of either embodiment 75 or embodiment 76, wherein the support comprises a polymer.
78. The method according to any one of embodiments 75-77, wherein the support is a bead, resin, or surface.
79. The method according to any one of embodiments 75-78, wherein the polymer is a hydrophobic polymer.
80. The method of embodiment 79, wherein the hydrophobic polymer is polystyrene.
81. The method according to any one of embodiments 75-80, wherein the metal selective chelating agent further comprises two or more chelating units attached to the support.
82. The method of embodiment 81, wherein the metal selective chelating agent further comprises a capping agent on any remaining reactive functional groups on the support.
83. The method according to any one of embodiments 75-80, wherein the metal selective chelating agent further comprises a linker between the chelating unit and the support.
84. The method of embodiment 83, wherein the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof.
85. The method of either embodiment 83 or embodiment 84, wherein the linker comprises two joining group selected from a carboxylic acid and an amine.
86. The method according to any one of embodiments 83-85, wherein the two joining groups are both carboxylic acids.
87. The method according to any one of embodiments 83-86, wherein the spacer is an alkanediyl_{(C<12)} or a substituted alkanediyl_{(C<12)}.
88. The method of embodiment 87, wherein the spacer is alkanediyl_{(C≤12)}.
89. The method of either embodiment 87 or embodiment 88, wherein the spacer is propanediyl.
90. The method according to any one of embodiments 1-89, wherein the method is conducted at a temperature above −80° C.
91. The method of embodiment 90, wherein the temperature is above −10° C.
92. The method of embodiment 91, wherein the temperature is above 10° C.
93. The method according to any one of embodiments 1-92, wherein the method is carried out at a temperature from about −30° C. to about 100° C.
94. The method of embodiment 93, wherein the temperature is from about −10° C. to about 75° C.
95. The method of either embodiment 93 or embodiment 94, wherein the temperature is from about 10° C. to about 40° C.
96. The method according to any one of embodiments 93-95, wherein the temperature is from about 20° C. to about 30° C.
97. The method according to any one of embodiments 93-96, wherein the temperature is room temperature.
98. The method according to any one of embodiments 1-97, wherein the aprotic solvent is an ether.
99. The method of embodiment 98, wherein the ether is an oxygen containing C3-C8 heterocycloalkane.
100. The method of either embodiment 98 or embodiment 99, wherein the ether is tetrahydrofuran.
101. The method of embodiment 98, wherein the ether is a C1-C12 dialkylether.
102. The method according to any one of embodiments 1-101, wherein the aprotic solvent is a nitrogen containing solvent.
103. The method of embodiment 102, wherein the nitrogen containing solvent is a C1-C8 cyanoalkane.
104. The method of either embodiment 102 or embodiment 103, wherein the nitrogen containing solvent is acetonitrile.
105. The method according to any one of embodiments 1-104, wherein the protic solvent is a hydroxy containing solvent.
106. The method of embodiment 105, wherein the hydroxy containing solvent is a C1-C12 alcohol.
107. The method of either embodiment 105 or embodiment 106, wherein the hydroxy containing solvent is methanol.
108. The method according to any one of embodiments 1-107, wherein the protic solvent is admixed with water.
109. The method of embodiment 108, wherein the method comprises using a solution comprising at least 90% protic solvent.
110. The method of embodiment 109, wherein the solution comprises at least 95% protic solvent.
111. The method of either embodiment 109 or embodiment 110, wherein the solution comprises at least 98% protic solvent.
112. The method according to any one of embodiments 1-111, wherein the method is conducted at a pressure from about 0.1 atm to about 5 atm.
113. The method of embodiment 112, wherein the pressure is from about 0.25 atm to about 2.5 atm.
114. The method of either embodiment 112 or embodiment 113, wherein the pressure is from about 0.5 atm to about 2 atm.
115. The method according to any one of embodiments 112-114, wherein the pressure is about 1 atm.
116. The method according to any one of embodiments 1-115, wherein the purified metal sample comprises at least 90% of the desired metal or metal salt.
117. The method according to any one of embodiments 1-116, wherein the purified metal sample comprises at least 92.5% of the desired metal or metal salt.
118. The method according to any one of embodiments 1-117, wherein the purified metal sample comprises at least 95% of the desired metal or metal salt.
119. The method according to any one of embodiments 1-118, wherein the purified metal sample comprises at least 97.5% of the desired metal or metal salt.
120. The method according to any one of embodiments 1-119, wherein the purified metal sample comprises at least 98% of the desired metal or metal salt.
121. The method according to any one of embodiments 1-120, wherein the purified metal sample comprises at least 99% of the desired metal or metal salt.
122. A composition comprising:
   (A) a support; and
   (B) a chelating unit of the formula:

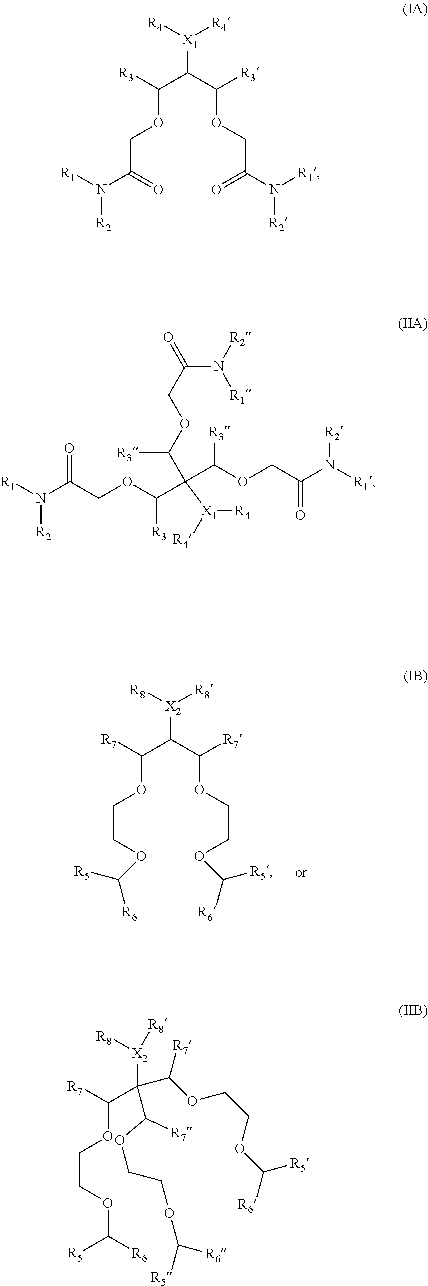

wherein:
   R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
   R₃, R₃′, R₃″, R₇, R₂′, and R₂″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
   R₄, R₄′, R₈, and R₈′ are hydrogen, a connection to a resin or polymer, or taken together as defined above; and
   X₁ and X₂ are each independently O or N.
123. The composition of embodiment 122, wherein the chelating unit is further defined as:

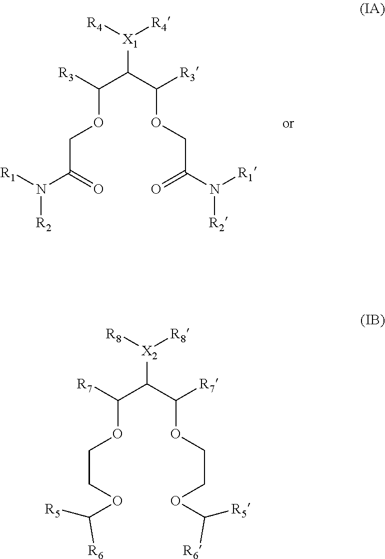

wherein:
   R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
   R₃, R₃′, R₇, and R₇′ are each independently hydrogen or R₃ and R₄, R₃′ and R₄′, R₇ and R₈, or R₇′ and R₈′ are joined together to form a 3-8 membered cycloalkane ring or a 3-8 membered heterocycloalkane ring;
   R₄, R₄′, R₈, and R₈′ are hydrogen, a bond to a support, or taken together as defined above; and
   X₁ and X₂ are each independently O or N.
124. The composition of either embodiment 122 or embodiment 123, wherein the chelating unit is further defined as:

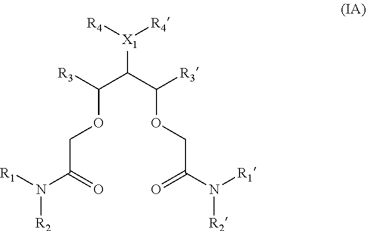

wherein:
   R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
   R₃ and R₃′ are each independently hydrogen or R₃ and R₄ or R₃′ and R₄′ are joined together to form a 3-8 membered cycloalkane ring or a 3-8 membered heterocycloalkane ring;
   R₄ and R₄′ are hydrogen, a connection to a resin or polymer, or taken together as defined above; and
   X₁ is O or N.
125. The composition of either embodiment 122 or embodiment 123 further defined as:

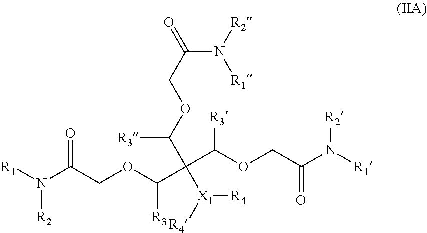

wherein:
   R₁, R₁′, R₁″, R₂, R₂′, and R₂″ are each independently cycloalkyh_{(C≤12)}, arylh_{(C≤12)}, heteroaryl_{(C≤12)}, heterocycloalkyl_{(C≤12)}, or a substituted version of any of these groups;
   R₃, R₃′, and R₃″ are each independently hydrogen or R₃ and R₄, R₃′ and R₄, and R₃″ and R₄″ are joined together to form a 3-8 membered cycloalkane ring or a 3-8 membered heterocycloalkane ring;
   R₄ and R₄′ are hydrogen, a bond to a support, or taken together as defined above; and
   X₁ and X₂ are each independently O or N.
126. The composition of either embodiment 122 or embodiment 124, wherein the chelating unit is further defined as:

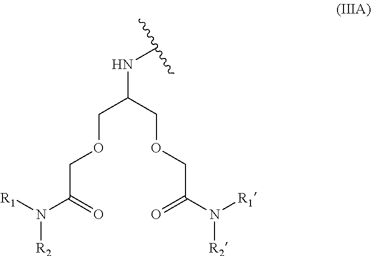

wherein:
   R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
   the open valence is connected to the support.
127. The composition according to any one of embodiments 122, 123, or 125, further defined as:

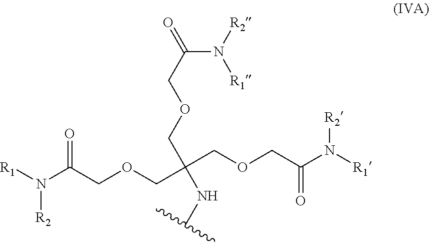

wherein:
   R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and
   the open valance is connected to a support.
128. The composition of embodiment 122, wherein the chelating unit is further defined as:

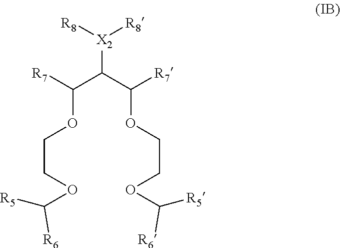

wherein:
   R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
   R₇ and R₇′ are each independently hydrogen or R₇ and R₈ or R₇′ and R₈′ are joined together to form a 3-8 membered cycloalkane ring or a 3-8 membered heterocycloalkane ring;
   R₈ and R₈′ are hydrogen, a connection to a resin or polymer, or taken together as defined above; and
   X₂ is OorN.
129. The composition of embodiment 122 further defined as:

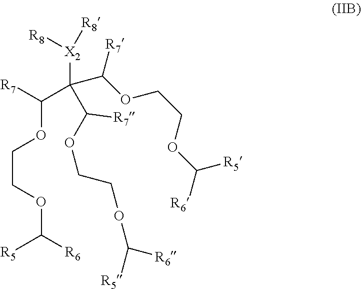

wherein:
   R₅, R₅′, R₅″, R₆, R₆, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
   R₇, R₇′, and R₇″ are each independently hydrogen or R₇ and R₈, R₇′ and R₈′, or R₇″ and R₈″ are joined together to form a 3-8 membered cycloalkane ring or a 3-8 membered heterocycloalkane ring;
   R₈ and R₈′ are hydrogen, a bond to a support, or taken together as defined above; and
   X₁ and X₂ are each independently O or N.
130. The composition of either embodiment 122 or embodiment 128 further defined as:

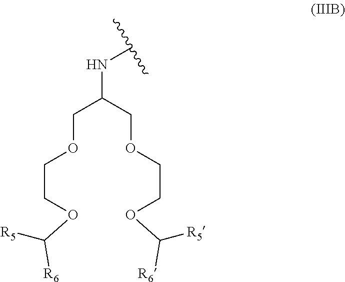

wherein:
   R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups; and
   the open valence is connected to the support.
131. The composition of embodiment 129 further defined as:

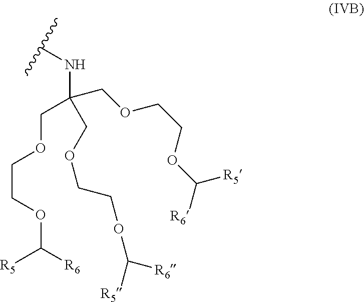

wherein:
   R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups; and the open valance is connected to a support.
132. The composition according to any one of embodiments 122-127, wherein R₁ is cycloalkyl_{(C≤12)} or substituted cycloalkyl_{(C≤12)}.
133. The composition of embodiment 132, wherein R₁ is cycloalkyl_{(C≤12)}.
134. The composition of either embodiment 132 or embodiment 133, wherein R₁ is cyclohexyl.
135. The composition according to any one of embodiments 122-127 and 132-134, wherein R₁′ is cycloalkyl_{(C≤12)} or substituted cycloalkyl_{(C≤12)}.
136. The composition of embodiment 135, wherein R₁′ is cycloalkyl_{(C≤12)}.
137. The composition of either embodiment 135 or embodiment 136, wherein R₁′ is cyclohexyl.
138. The composition according to any one of embodiments 122-127 and 132-137, wherein R₁″ is cycloalkyl_{(C≤12)} or substituted cycloalkyl_{(C≤12)}.
139. The composition of embodiment 138, wherein R₁″ is cycloalkyl_{(C≤12)}.
140. The composition of either embodiment 138 or embodiment 139, wherein R₁″ is cyclohexyl.
141. The composition according to any one of embodiments 122-127 and 132-137, wherein R₂ is cycloalkyl_{(C≤12)} or substituted cycloalkyl_{(C≤12)}.
142. The composition of embodiment 141, wherein R₂ is cycloalkyl_{(C≤12)}.
143. The composition of either embodiment 141 or embodiment 142, wherein R₂ is cyclohexyl.
144. The composition according to any one of embodiments 122-127 and 132-143, wherein R₂′ is cycloalkyl_{(C≤12)} or substituted cycloalkyl_{(C≤12)}.
145. The composition of embodiment 144, wherein R₂′ is cycloalkyl_{(C≤12)}.
146. The composition of either embodiment 144 or embodiment 145, wherein R₂′ is cyclohexyl.
147. The composition according to any one of embodiments 122-127 and 132-146, wherein R₂″ is cycloalkyl_{(C≤12)} or substituted cycloalkyl_{(C≤12)}.
148. The composition of claim 147, wherein R₂″ is cycloalkyl_{(C≤12)}.
149. The composition of either claim 147 or claim 148, wherein R₂″ is cyclohexyl.
150. The composition according to any one of embodiments 122, 123, and 128-131, wherein R₅ is cycloalkyl_{(C≤12)} or substituted cycloalkyl_{(C≤12)}.
151. The composition of embodiment 150, wherein R₅ is cycloalkyl_{(C≤12)}.
152. The composition of either embodiment 150 or embodiment 151, wherein R₅ is cyclohexyl.
153. The composition according to any one of embodiments 122, 128-131, and 150-152, wherein R₅′ is cycloalkyl_{(C≤12)} or substituted cycloalkyl_{(C≤12)}.
154. The composition of embodiment 153, wherein R₅′ is cycloalkyl_{(C≤12)}.
155. The composition of either embodiment 153 or embodiment 154, wherein R₅′ is cyclohexyl.
156. The composition according to any one of embodiments 122, 128-131, and 150-155, wherein R₅″ is cycloalkyl_{(C≤12)} or substituted cycloalkyl_{(C≤12)}.
157. The composition of embodiment 156, wherein R₅″ is cycloalkyl_{(C≤12)}.
158. The composition of either embodiment 157 or embodiment 158, wherein R₅″ is cyclohexyl.
159. The composition according to any one of embodiments 122, 128-131, and 150-155, wherein R₆ is cycloalkyl_{(C≤12)} or substituted cycloalkyl_{(C≤12)}.
160. The composition of embodiment 159, wherein R₆ is cycloalkyl_{(C≤12)}.
161. The composition of either embodiment 159 or embodiment 160, wherein R₆ is cyclohexyl.
162. The composition according to any one of embodiments 122, 128-131, and 150-161, wherein R₆′ is cycloalkyl_{(C≤12)} or substituted cycloalkyl_{(C≤12)}.
163. The composition of embodiment 162, wherein R₆′ is cycloalkyl_{(C≤12)}.
164. The composition of either embodiment 162 or embodiment 163, wherein R₆′ is cyclohexyl.
165. The composition according to any one of embodiments 122, 128-131, and 150-164, wherein R₆″ is cycloalkyl_{(C≤12)} or substituted cycloalkyl_{(C≤12)}.
166. The composition of embodiment 165, wherein R₆″ is cycloalkyl_{(C≤12)}.
167. The composition of either embodiment 165 or embodiment 166, wherein R₆″ is cyclohexyl.
168. The composition according to any one of embodiments 122-167, wherein the support is a hydrophobic support.
169. The composition according to any one of embodiments 122-168, wherein the support comprises a polymer.
170. The composition according to any one of embodiments 122-169, wherein the support is a bead, resin, or surface.
171. The composition according to any one of embodiments 122-170, wherein the polymer is a hydrophobic polymer.
172. The composition of embodiment 171, wherein the hydrophobic polymer is polystyrene.
173. The composition according to any one of claims 122-172, wherein the composition further comprises two or more chelating units attached to the support.
174. The composition of embodiment 173, wherein the metal selective chelating agent further comprises a capping agent on any remaining reactive functional groups on the support.
175. The composition according to any one of embodiments 122-174, wherein the chelating unit and the support are joined by a linker between the chelating unit and the support.
176. The composition of embodiment 175, wherein the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof.
177. The composition of either embodiment 175 or embodiment 176, wherein the linker comprises two joining group selected from a carboxylic acid and an amine.
178. The composition of either embodiment 176 or embodiment 177, wherein the two joining groups are both carboxylic acids.
179. The composition according to any one of embodiments 176-178, wherein the spacer is an alkanediyl_{(C≤12)} or a substituted alkanediyl_{(C≤12)}.
180. The composition of embodiment 179, wherein the spacer is alkanediyl_{(C≤12)}.
181. The composition of either embodiment 179 or embodiment 180, wherein the spacer is propanediyl.
182. A method of purifying a metal comprising exposing a composition containing the metal to purified to a composition according to any one of embodiments 122-182.
183. The method of embodiment 182, wherein the metal is lithium.
184. The method of embodiment 182, wherein the metal is cobalt.
185. The method of embodiment 182, wherein the metal is nickel.
186. The method of embodiment 182, wherein the metal is lanthanum.
187. A method of recycling the metal ions in a battery comprising contacting the components of the battery to a composition according to any one of embodiments 122-182.

### EXAMPLES

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1: Synthesis and Characterization of Polymers P1-P3

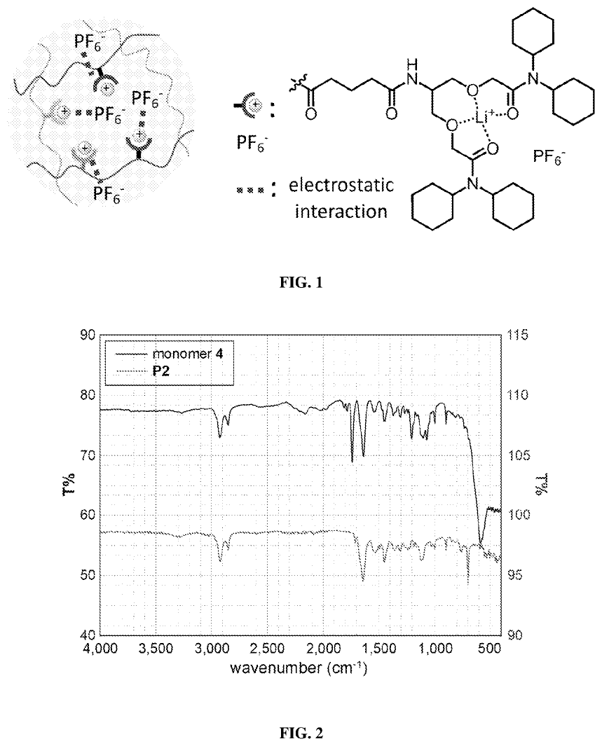

Resins designed for LiPF₆ sequestration were considered as illustrated in FIG. 1. To that end, resin-bound receptors were synthesized. The immobilized receptor used in the present study (P2) was synthesized according to Scheme 1.

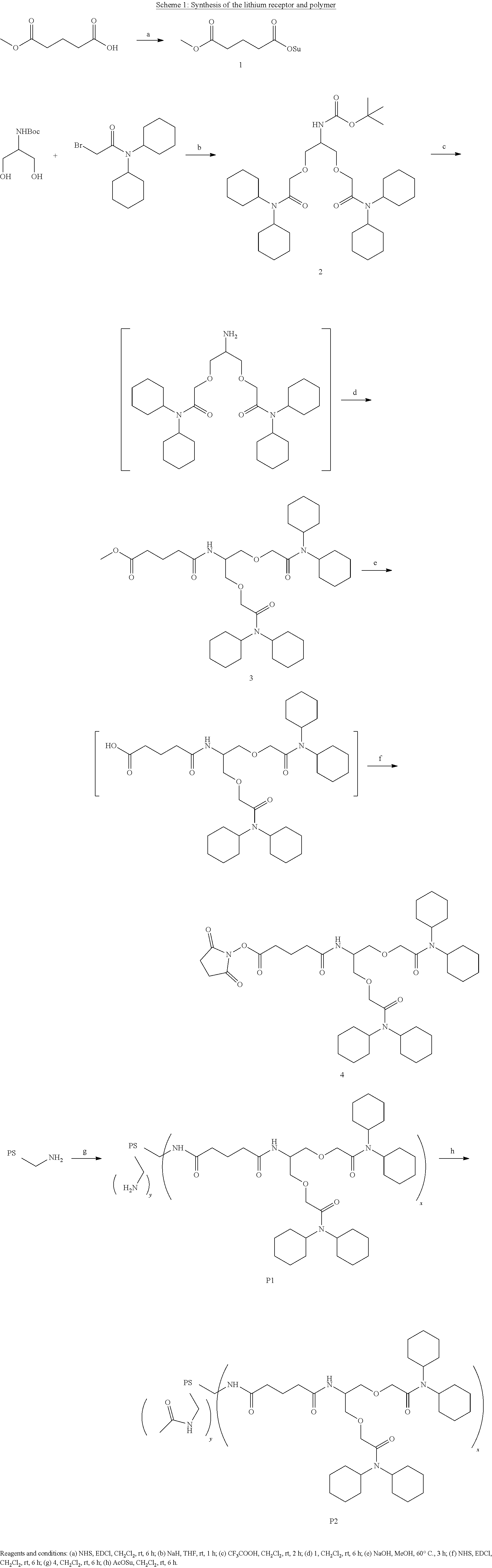

In the first step, a five-carbon linker 1 that was designed to allow attachment of the BDCA Li⁺ receptor onto a polystyrene support was prepared by activating monomethyl glutarate with N-hydroxysuccinimide (NHS)/1-ethyl-3-(3-dimethylaminopropyl) carbodiimide hydrochloride (EDCI) to give the activated ester 1. Separately, reaction of BOC-protected serinol and bromo dicyclohexylacetamide yielded the core binding scaffold 2. Deprotection with TFA and acylation with linker 1 gave compound 3. Saponification with NaOH and activation with NHS/EDCI yielded monomer 4. An NHS ester-amine coupling to a commercially available aminomethyl polystyrene resin then gave P1. Capping the unreacted amino groups with N-acetoxysuccinimide yielded P2. A fully acetyl capped aminomethyl polystyrene P3 was also prepared as a control according to Scheme 2.

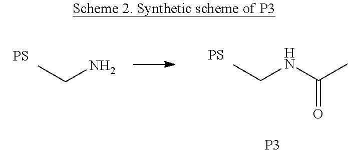

These synthetic transformations are described in more detail below.

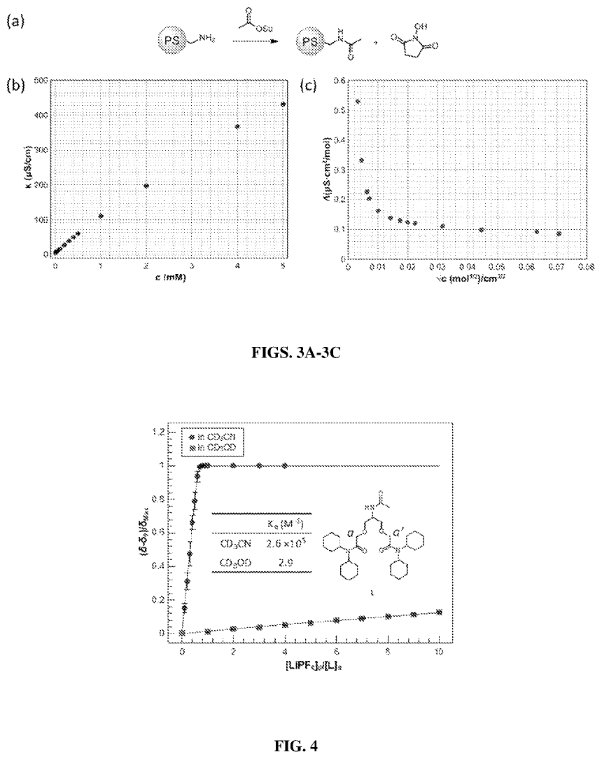

Attenuated total reflection-infrared (ATR-IR) spectroscopy of P2 revealed characteristic peaks for both the polystyrene core and the BDCA subunits (FIG. 2). The disappearance of the C═O stretching present in the NHS ester 4 (1750 cm⁻¹) was taken as evidence of successful immobilization of this key intermediate onto the polymeric support to produce first P1 and then P2. Unfortunately, polymer P1, as well as polymers P2 and P3, could not be weighed accurately due to static electricity effects, precluding reliable elemental combustion analyses. However, an estimate of the loading level (1.4 mmol/g (x=1.4, y=0.1, where x and y denote the loading levels of monomer 4 and amine, respectively)) of precursor 4 onto P1 was made by measuring the conductivity change induced as the NHS activating subunit was released into water (FIG. 3) The loading was determined by conductivity measurements involving the eliminated N-hydroxysuccinimide (NHS) in water. Since NHS is highly water soluble while both the polymer and N-acetoxysuccinimide have negligible water solubility, the conductivity change of the aqueous solution was considered, without being bound by theory, to directly reflect the concentration of the NHS. The method was first verified by comparing the loading of amine provided by the manufacture to that determined using this conductivity protocol. Specifically, this procedure yielded values between 1.42 mmol/g-1.60 mmol/g, in close agreement with 1.5 mmol/g indicated in the manufacturer's certificate of analysis.

### Example 2: LiPF₆ Binding Studies

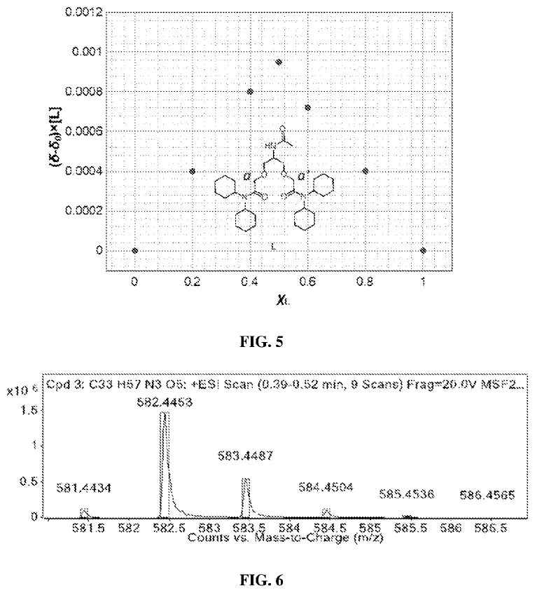

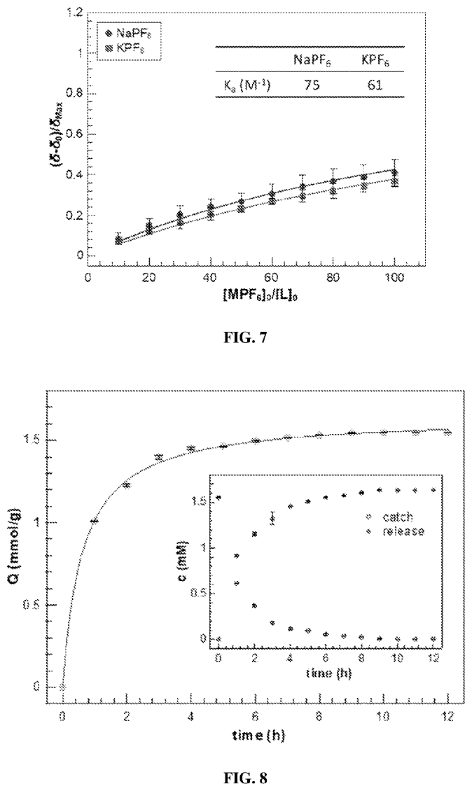

The reversibility of LiPF₆ binding by the functionalized solid support (P2) was first assessed by means of NMR spectroscopic titrations of the constituent BDCA lithium receptor in acetonitrile and methanol. Since the t-butoxy group of 2 could potentially interact with lithium salts, an acetyl protected analogue of 2, termed L, was prepared for these studies (Scheme 3 and FIG. 4). In acetonitrile, L binds Li⁺ (studied as the PF₆⁻ salt) strongly with a calculated K_{a, ACN}=2.6×10⁵ M⁻¹ based on a 1:1 binding stoichiometry that was derived from a Job's plot (FIG. 5). The 1:1 binding stoichiometry was further supported by the observed isotopic distribution in the ESI-HRMS spectrum of L·LiPF6 (FIG. 6). A much lower binding affinity was recorded in methanol (K_{a, MeOH}=2.9 M⁻¹). Ligand L was also found to have a high selectivity for LiPF₆ over the corresponding Na⁺ (K_{a, ACN}=75 M⁻¹) and K+(K_{a, ACN}=61 M⁻¹) salts (FIG. 7).

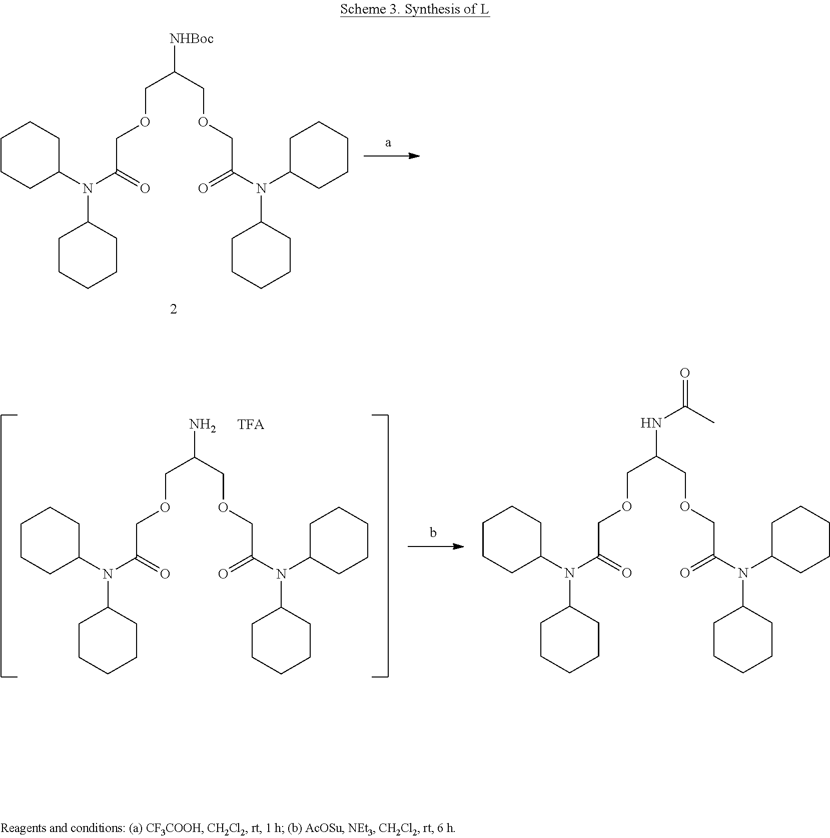

Next, the interactions between LiPF₆ and P2 were tested. A decrease in the LiPF₆ concentration of an initial 1.55 mM solution in acetonitrile was observed as a function of time after exposing to P2 (FIG. 8, inset). Notably, over 90% of the LiPF₆ was sequestered within 4 h. A pseudo-second order adsorption model could be used to fit (R²=0.999) the kinetics of the presumed LiPF₆ absorption process (FIG. 8). An equilibrium capacity Q_{eq}=1.65 mmol/g and a rate constant k=0.98 g·mmol⁻¹ h⁻¹ could be calculated using this model (Simonin, 2016).

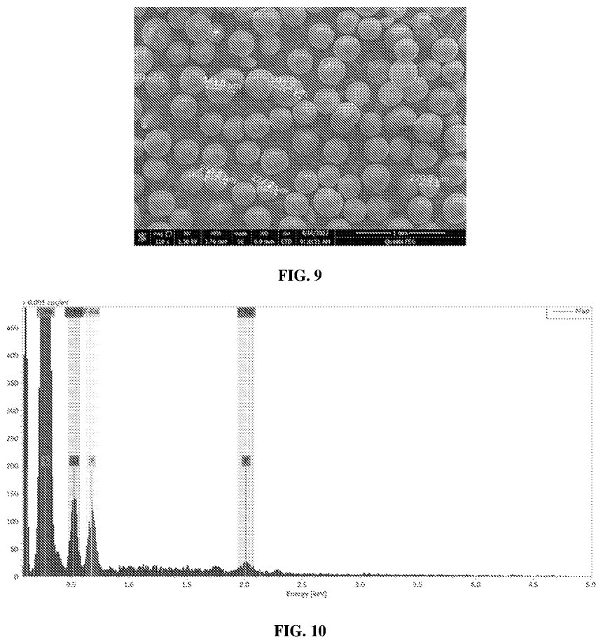

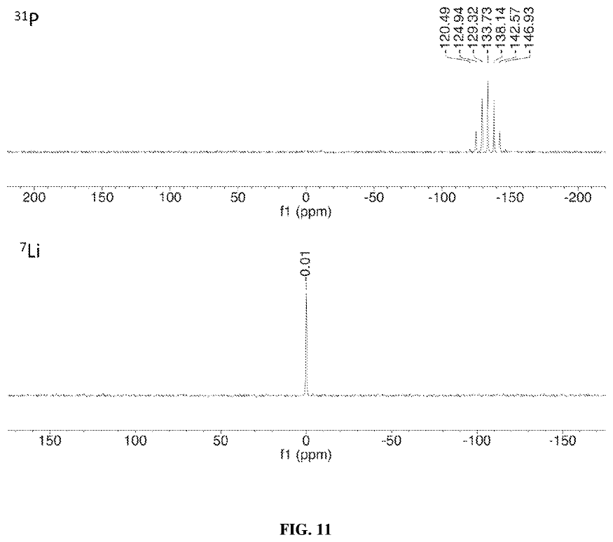

Scanning electron microscopy in conjunction with energy dispersive X-ray (SEM-EDX) analysis provided morphological and elemental information of the resin samples obtained via simple filtration, thorough washing with acetonitrile, and drying (hereinafter P2·LiPF₆). The P2·LiPF₆ resin samples prepared in this way proved uniformly spherical in morphology, with diameters ranging from 220 μm to 350 μm (FIG. 9). A ratio of 6:1 between the Kα X-ray emissions from F and P provides support for the contention that LiPF₆ is captured effectively by P2 (cf. FIG. S12, Table 1).

TABLE 1
Elemental analysis of P2•LiPF₆ by EDX

| | Mass | Mass Norm. | Atom |
|---|---|---|---|
| Element | [%] | [%] | [%] |
| Carbon | 79.29103 | 79.29103 | 85.2648381 |
| Oxygen | 9.6631873 | 9.6631873 | 7.80084737 |
| Phosphorus | 2.18786594 | 2.18786594 | 0.9123298 |
| Fluorine | 8.85791678 | 8.85791678 | 6.02198471 |
| | 100 | 100 | 100 |

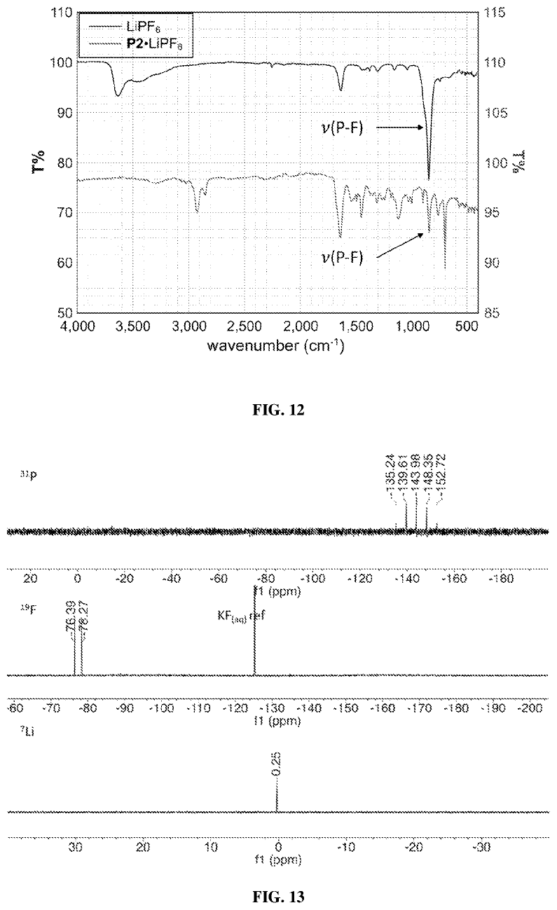

Further evidence came from solid state NMR spectroscopic analyses of P2·LiPF₆. These latter studies revealed the characteristic septet of PF6⁻ in the ³¹P NMR spectrum, as well as a singlet characteristic of Li⁺ in the ⁷Li NMR spectrum (FIG. 11). No signals from impurities were detected. Due to the strong anisotropy exhibited by ¹⁹F in the solid state, detection of this nucleus proved instrumentally limited. A strong, diagnostic P-F stretching signal at 850 cm⁻¹ was seen in the ATR-IR spectrum of P2 after mixing with LiPF₆ (FIG. 12).

P2·LiPF₆ was physically isolated from the initial acetonitrile and then placed into anhydrous methanol. This led to an increase in the conductivity of the methanolic medium as a function of time corresponding to a time-dependent increase in the free LiPF₆ concentration (FIG. 8, inset). Approximately 90% of the bound LiPF₆ is released within 4 h.

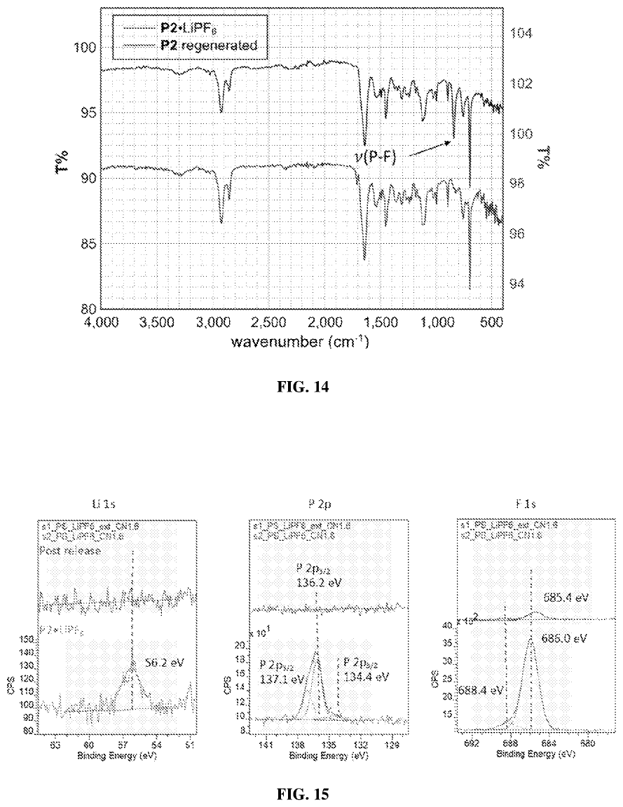

The resulting methanolic solution was further characterized by solution phase ¹⁹F, ³¹P, and ⁷Li NMR spectroscopies, all of which provided support for the presence of free LiPF₆ (FIG. 13). The near-complete reduction in the P-F stretching band at 850 cm⁻¹ in the ATR-IR spectrum of P2 recorded after 4 hours of contact with methanol leads to the conclusion, without being bound by theory, that the release of LiPF₆ is close to quantitative under these conditions (FIG. 14). X-ray photoelectron spectroscopic (XPS) analyses were also carried out (FIG. 15). In the case of P2·LiPF₆ characteristic Li 1S, P 2P, and F 1S signals were observed, whereas weak to no signals were seen for P2 after the release of LiPF₆. Quantification by XPS proved consistent with the observation that, again without being bound by theory, LiPF₆ on the surface of P2·LiPF₆ is far more prone to hydrolysis as compared to that bound within the resin (FIG. 15). Collectively, these results support the hypothesis that, without being bound by theory, the immobilized neutral lithium receptor takes up LiPF₆ effectively in acetonitrile and releases it with high fidelity in methanol as the result of solvent polarity switching.

### Example 3: Reusability of the Polymer

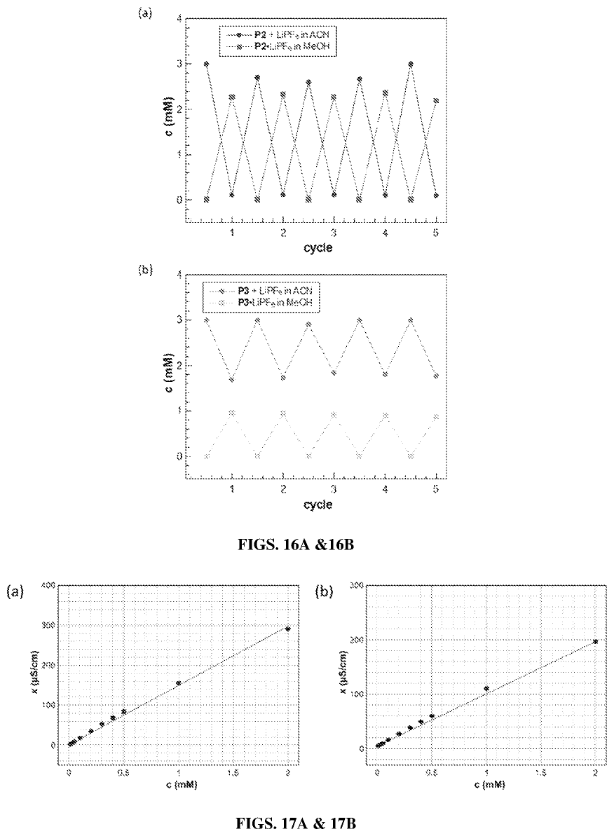

Cycles of catch and release were performed on P2 to evaluate its potential reusability. The conductivity of an initial 5 mL, 3.0 mM LiPF₆ solution in acetonitrile was found to decrease uniformly from 400 μS/cm to 20 μS/cm after contact with 10 mg of P2 for 12 h. This corresponds to a 98% reduction in the initial free LiPF₆ value to a final value of approximately 0.063 mM during each cycle (FIG. 16A, FIG. 17). Subsequent release cycles were characterized by an increase from 1.2 μS/cm to 221 μS/cm, corresponding to initial and final LiPF₆ concentrations of 0 mM and 2.4 mM, respectively. No significant decrease in the catch and release efficiency was observed for at least 5 cycles.

It was found that the control polymer P3 lacking the BDCA lithium receptor was also able to catch and release LiPF₆ (FIG. 16B); however, it proved far less effective in this regard than P2. Only 34% of LiPF6 was captured and released by P3 under conditions identical to those where 98% binding and release was seen using P2. The ability of P3 to capture some LiPF₆ is not surprising since even simple amides are known to bind lithium, albeit not well (Bochenska and Gdaniec, 1994; Kamenica et al., 2017; Villemin and Raccurt, 2021).

### Example 4: Catch and Release of LiPF₆ from Model Degraded Electrolyte

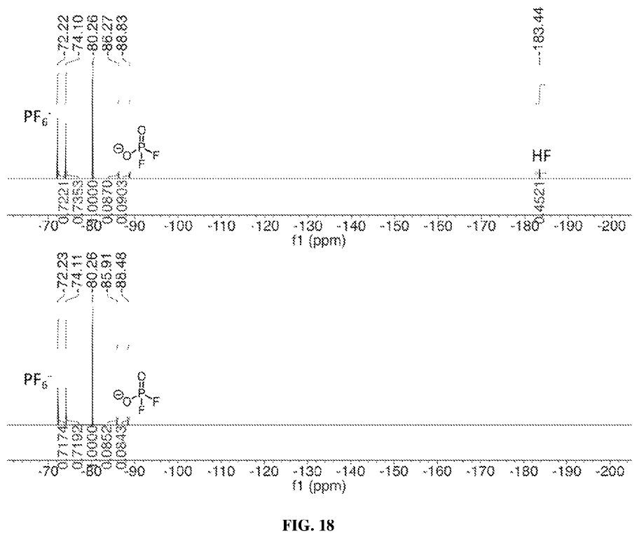

A typical degraded LiPF₆ electrolyte contains HF, LiF, fluorophosphate, difluorophosphate, and other organophosphates (Terborg et al., 201; Parimalam et al., 2017; Yang et al., 2006; Wilken et al., 2013). The capacity of P2 to recover LiPF₆ from samples meant to model LiPF₆ degradation was thus tested. Samples simulating 9%, 29%, 46%, 69%, and 87% decomposition were thus made up in 50% ethylene carbonate (EC)/50% diethyl carbonate (DEC) in accord with a reported procedure (Zheng et al., 2016). Applied coaxial quantitative ¹⁹F NMR (qNMR) spectroscopy was used to determine the absolute concentrations of LiPF₆ and impurities (Henderson, 2002; Wiemers-Meyer et al., 2016). The results are summarized in Table 2. Due to safety concern associated with HF and glass etching, anhydrous K₂CO₃(s) was first added to the solutions until neutral per a litmus test. Treatment with K₂CO₃(s) effectively removed HF but did not affect the LiPF₆ levels (FIG. 18).

TABLE 2
Concentration changes corresponding to the catch & release of PF₆−
and PO₂F₂− from a simulated degraded electrolyte using P2.

| | Percentage of LiPF₆ degradation | | | | | | | | | |
|---|---|---|---|---|---|---|---|---|---|---|
| | 9% | | | | | 29% | | | | |
| | | [symbol] | | [symbol] | | | [symbol] | | [symbol] | |
| PF₆^{_{−}} (mM) | 45.9 | | 3.15 | | 40.4 | 35.6 | | 3.77 | | 29.1 |
| PO₂F₂^{_{−}} (μM) | 0.850 | | 0.282 | | 0.900 | 1.60 | | 0.188 | | 2.2 |

| | Percentage of LiPF₆ degradation | | | | | | | | | |
|---|---|---|---|---|---|---|---|---|---|---|
| | 46% | | | | | 69% | | | | |
| | | [symbol] | | [symbol] | | | [symbol] | | [symbol] | |
| PF₆^{_{−}} (mM) | 26.4 | | 2.2 | | 22.2 | 15.0 | | 1.67 | | 10.5 |
| PO₂F₂^{_{−}} (μM) | 4.55 | | 0.00 | | 1.90 | 0.8 | | 0.00 | | 1.00 |

| | Percentage of LiPF₆ degradation | | | | |
|---|---|---|---|---|---|
| | 87% | | | | |
| | | [symbol] | | [symbol] | |
| PF₆^{_{−}} (mM) | 12.7 | | 2.08 | | 12.5 |
| PO₂F₂^{_{−}} (μM) | 0.1 | | 0.00 | | 0.100 |

Conditions: 0.1 M LiPF₆ in 50% ethylene carbonate (EC)/50% diethyl carbonate (DEC) was heated at 85° C. over a week, during which time aliquots were cooled, neutralized with K₂CO_{3(g)}, and characterized by ¹⁹F qNMR spectroscopy. All solutions were prepared fresh and under N₂. 2 mL of each K₂CO_{3(g)} neutralized solution was diluted with 2 mL acetonitrile and added to P2 (54.7 mg, 40.4 mg, 30.6 mg, 17.0 mg, and 14.9 mg). An equilibrium time of 12 h was used for each capture and release experiment. The resin was then washed thoroughly with anhydrous acetonitrile and dried under high vacuum before being exposed to 4 mL of anhydrous methanol to effect release of the LiPF₆.

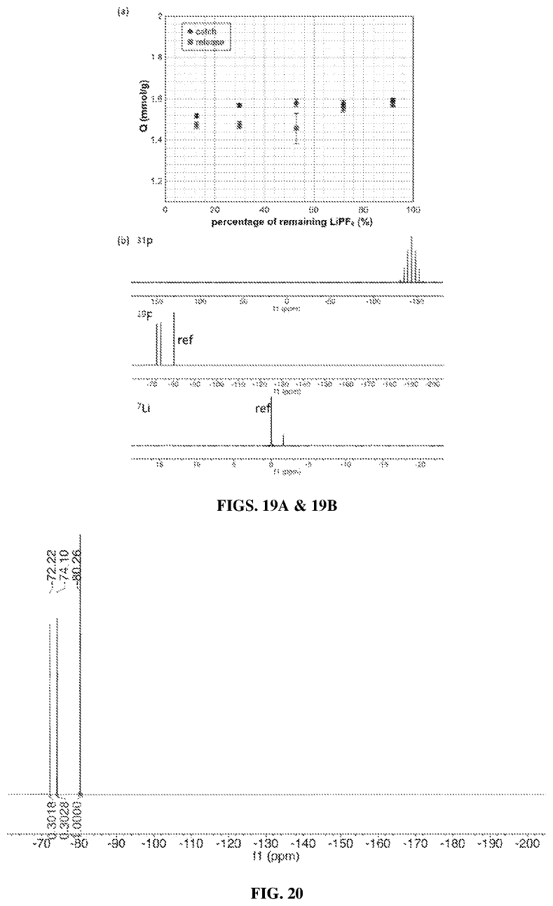

The capacity of P2 to catch and release LiPF₆ can be derived from the LiPF₆ concentration changes in acetonitrile and in methanol (Table 2, FIG. 19A). Across the series of samples, the LiPF₆ uptake capacities range from 1.44-1.60 mmol/g, whereas the extent of LiPF₆ release was found to vary from 1.47 to 1.60 mmol/g (FIG. 19A). These values represent only an 8% and 7% decrease from the equilibrium capacity Qeq (1.65 mmol/g) that was previously determined via the kinetic studies discussed above (FIG. 8). A small percentage of difluorophosphate was, however, detected in the methanolic solution (Table 2).

Under the conditions of the study, the difluorophosphate concentration was found to decrease upon exposure to P2. This suggests, without being bound by the theory, that this impurity is also captured and released via the present polarity switching process. While difluorophosphate found after the uptake and release process largely reflects what was present in the initial simulated degraded LiPF₆ solutions (Table 2), studies have shown that alcohols present in battery electrolytes can induce LiPF₆ degradation in spite of relatively slow kinetics at room temperature (Zheng et al., 2016; Campion et al., 2004). As such, use of anhydrous methanol as described herein could, without being bound by theory, contribute to the formation of difluorophosphate. Nevertheless, a simple diethyl ether trituration of the LiPF₆ obtained after drying the methanol release phase effectively removed this impurity.

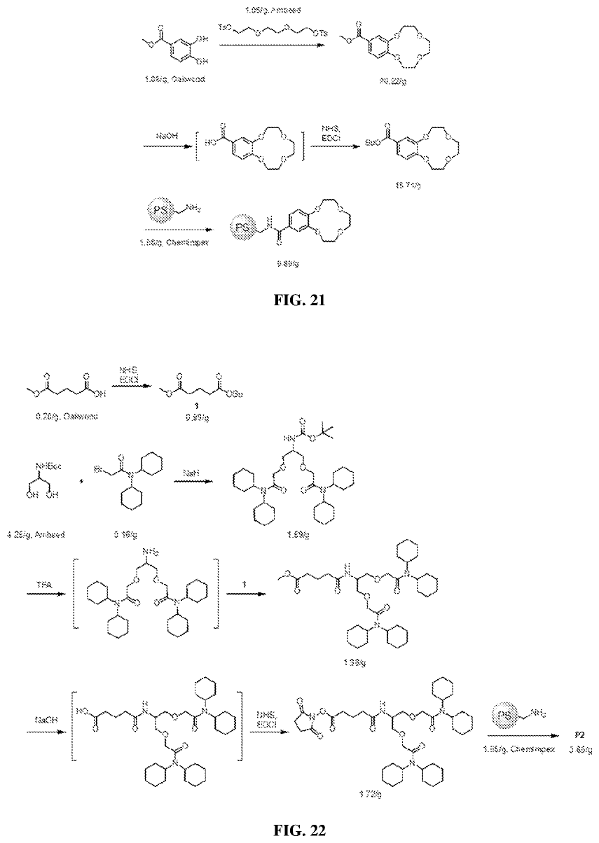

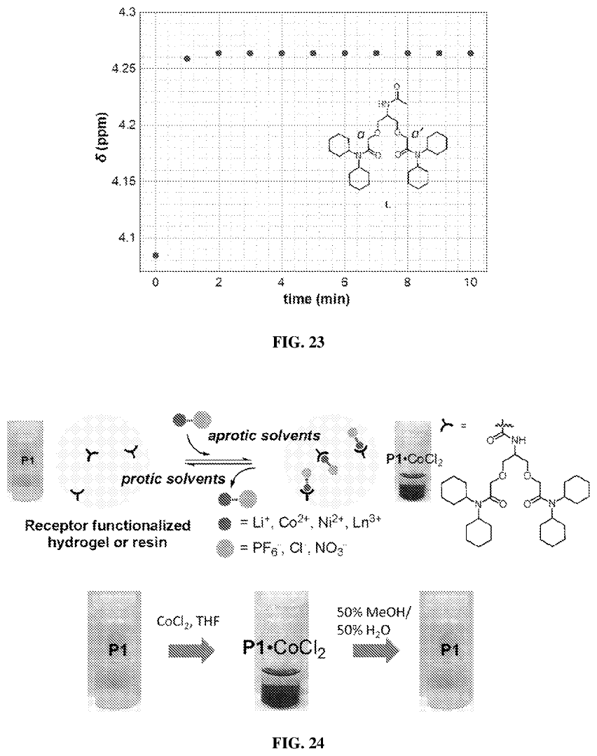

After the catch and release operation involving the simulated degradation samples, only signals corresponding to LiPF₆ were detected by ³¹P, ¹⁹F, and ⁷Li NMR spectroscopy (FIG. 19B). The purity was determined to be 99.68% by quantitative ¹⁹F NMR analysis (FIG. 20). This high inferred purity was further supported by inductively coupled plasma mass spectrometry (ICP-MS) analysis of trace-metal content. Since each step involved in the catch and release of LiPF₆ could potentially introduce trace metals contaminants, the presence of any such trace metal contaminants was investigated. In accord with the still-under-development standards suggested by the International Organization for Standardization (ISO)/AWI 10655, (ISO Standard) the levels of 12 possible metal contents, along with those of Li and P, were determined (Table 3). Importantly, despite the use of K₂CO₃₍ₛ₎ for neutralizing the HF, only a background level of K⁺ was detected. Such a low level of K⁺ may be, without being bound by theory, attributed to the high selectivity of the BDCA subunit for Li⁺ over K⁺. A total trace-metal content less ≤300 ppm was determined based on the ICP-MS analysis; which is in agreement with the high purity inferred from the qNMR studies discussed above. The use of acyclic BDCA also offers the advantage of lower cost (estimated to $3.65/g) in comparison to a representative lithium selective crown-ether counterpart (estimated to be $9.89/g) (see FIG. 21 and FIG. 22). This bodes well for potential industrial applications

TABLE 3
ICP-MS result of the recovered product

| | Li | P | Al | Ca | Cd | Cr | Cu |
|---|---|---|---|---|---|---|---|
| Background (ppb) | — | 2.72 | 27.58 | 69.28 | — | 0.07323 | 0.04638 |
| Sample (ppb) | 10.12 | 41.64 | 23.79 | 68.57 | — | 0.01601 | 0.02872 |
| | Fe | K | Mg | Na | Ni | Pd | Zn |
| Background (ppb) | 7.917 | 2.667 | 1.473 | 35.0 | 0.02295 | 0.06814 | 0.1591 |
| Sample (ppb) | 2.605 | 1.262 | 1.418 | 24.4 | 0.01041 | 0.06503 | 0.2253 |

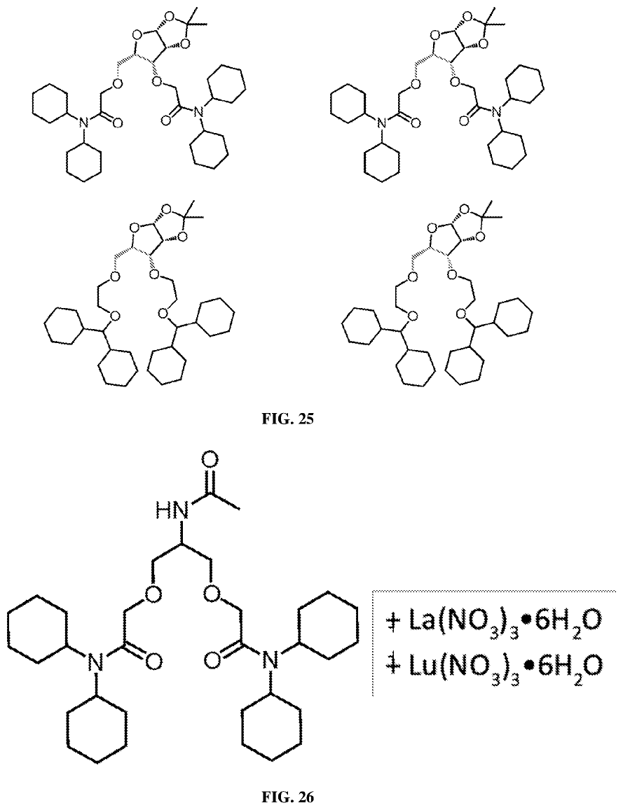

The methods and compounds described herein may also be used to catch and release other metal complexes, such as cobalt, nickel, or lanthanum complexes of a variety of counterions, such as chlorides or nitrates (see FIG. 24). Additional receptors are provided in FIG. 25. The receptor depicted in FIG. 26 has been shown to bind lanthanide complexes.

### Example 5: Materials and Methods

### Synthetic Procedures

2-Bromo-N,N-dicyclohexylacetamide was prepared according to a reported procedure.¹ The structure was characterized and confirmed by ¹H and ¹³C NMR spectroscopy, as well as ESI-HRMS.

2,5-Dioxopyrrolidin-1-yl methyl glutarate 5-methoxy-5-oxopentanoate (1). Monomethyl glutarate (811 mg, 5.55 mmol), 1-ethyl-3-(3-dimethylaminopropyl)carbodiimide hydrochloride (EDCI) (1.06 g, 5.55 mmol), and N-hydroxysuccinimide (639 mg, 5.55 mmol) were dissolved in methylene chloride (50 mL). The solution was stirred at room temperature for 6 h before washing with saturated NaHCO_{3(aq)}. The washed organic layer was dried over anhydrous MgSO_{4(g)}, filtered, and concentrated under reduced pressure. The residue was purified by flash chromatography over silica gel using 55% ethyl acetate/45% hexanes as the eluent to yield 1 as colorless liquid. (1.21 g, 90%). ¹H NMR (400 MHz, CDCl₃): δ=3.63 (s, 3H), 2.78 (s, 4H), 2.65 (t, 2H, J=8 Hz), 2.42 (t, 2H, J=8 Hz), 2.06-1.96 (m, 2H). ¹³C NMR (100 MHz, CDCl₃): 3=172.81, 169.25, 168.07, 51.61, 32.30, 29.90, 25.50, 19.68. ESI-HRMS: m/z=266.0643 ([M+H]⁺), (calcd. 266.0635).

Tert-butyl (1,3-bis(2-(dicyclohexylamino)-2-oxoethoxy)propan-2-yl)carbamate-tert-butyl (1,3-dihydroxypropan-2-yl)carbamate-2-bromo-N,N-dicyclohexylacetamide (2). To a suspension of 60% NaH (188 mg, 4.71 mmol) in anhydrous THF (20 mL) was added BOC-protected serinol (300 mg, 1.57 mmol). After the effervescence stopped, 2-bromo-N,N-dicyclohexylacetamide (948 mg, 3.14 mmol) dissolved in anhydrous THF (10 mL) was slowly injected into the NaH solution. After allowing to sit for 1 h at room temperature, water was slowly added to the mixture. The volatiles were then removed under vacuum. The residue was then dissolved in CH₂C1₂, washed with water, dried over MgSO_{4(g)}, filtered, and concentrated under reduced pressure. The residue was purified by flash chromatography over silica gel using 40% ethyl acetate/60% hexanes as the eluent to yield 2 as foam-like liquid. (796 mg, 80%). ¹H NMR (400 MHz, CDCl₃): δ=4.12-4.02 (m, 4H), 3.83 (br, 1H), 3.71-3.50 (m, 4H), 3.31 (br, 2H), 2.90 (br, 2H), 2.43 (br, 4H), 1.84-1.72 (m, 8H), 1.72-1.61 (m, 6H), 1.56 (br, 2H), 1.52-1.42 (m, 8H), 1.42-1.38 (m, 9H), 1.34-1.02 (m, 13H). ¹³C NMR (100 MHz, CDCl₃): 3=168.15, 155.75, 79.19, 71.55, 70.18, 57.17, 56.26, 31.35, 29.96, 28.49, 26.68, 26.00, 25.41, 25.33. ESI-HRMS: m/z=634.4790 ([M+H]⁺), (calcd. 634.4790).

Methyl 5-((1,3-bis(2-(dicyclohexylamino)-2-oxoethoxy)propan-2-yl)amino)-5-oxopentanoate-2,2′-((2-aminopropane-1,3-diyl)bis(oxy))bis(N,N-dicyclohexylacetamide) (3). Compound 2 (753 mg, 1.19 mmol) was first dissolved in CH₂Cl₂(10 mL) before trifluoroacetic acid (10 mL) was slowly added to the solution. After stirring at room temperature for 2 h, the volatiles were removed under high vacuum. The residue was dissolved in CH₂Cl₂ (10 mL) and neutralized with 1N aqueous NaOH. The organic layer was separated, dried over anhydrous MgSO_{4(g)}, filtered, and concentrated under reduced pressure. The residue was redissolved in CH₂Cl₂ (10 mL) and combined with a CH₂Cl₂ (10 mL) solution of the glutarate linker 1 (289 mg, 1.19 mmol) and allowed to react at room temperature for 6 h. After washing with saturated NaHCO₃(ag), the organic layer was dried over anhydrous MgSO_{4(g)}, filtered, and concentrated under reduced pressure. The residue was purified by flash chromatography over silica gel using 100% ethyl acetate to yield 3 as colorless liquid. (591 mg, 75%). ¹H NMR (400 MHz, CDCl₃): 3=8.02 (br, 1H), 4.16-3.99 (m, 5H), 3.76-3.69 (m, 2H), 3.63 (s, 3H), 3.60-3.50 (m, 2H), 3.22 (br, 2H), 2.90 (br, 2H), 2.55-2.31 (m, 6H), 2.31-2.18 (m, 2H), 2.04-1.92 (m, 2H), 1.85-1.71 (m, 8H), 1.71-1.60 (m, 6H), 1.60-1.53 (m, 2H), 1.53-1.38 (m, 8H), 1.34-0.99 (m, 13H). ¹³C NMR (100 MHz, CDCl₃): 3=173.73, 172.59, 168.31, 70.69, 69.78, 56.77, 56.19, 51.54, 49.64, 5.67, 33.53, 31.26, 30.00, 26.66, 25.97, 25.44, 25.27, 20.98. ESI-HRMS: m/z=662.4737 ([M+H]⁺), (calcd. 662.4739).

2,5-Dioxopyrrolidin-1-yl 5-((1,3-bis(2-(dicyclohexylamino)-2-oxoethoxy)propan-2-yl)amino)-5-oxopentanoate (4). Compound 3 (507 mg, 0.766 mmol) was dissolved in MeOH (10 mL) and saponified using 1N NaOH (2.3 mL) at 60° C. for 3 h. After removing MeOH under vacuum, to the residue was added water (5 mL) and acidified with 1N HCl until a pH=3 was reached. The aqueous solution was then extracted with CH₂Cl₂ (3×10 mL). The organic layers were combined, dried over anhydrous MgSO_{4(g)}, filtered, and concentrated under reduced pressure. NHS (88.0 mg, 0.766 mmol), EDCI (147 mg, 0.766 mmol), and the residue were dissolved in CH₂Cl₂ (10 mL). The mixture was stirred at room temperature for 6 h. The mixture was then washed with 0.1 N aqueous HCl (10 mL). The organic layer was separated, dried over anhydrous MgSO_{4(g)}, filtered, and concentrated under reduced pressure. The residue was purified by flash chromatography over silica gel using 100% ethyl acetate to yield monomer 4 as foam-like liquid. (542 mg, 95%). ¹H NMR (400 MHz, CDCl₃): δ=7.92 (br, 1H), 4.08-3.89 (m, 5H), 3.67-3.57 (m, 2H), 3.53-3.40 (m, 2H), 3.15 (br, 2H), 2.82 (br, 2H), 2.72 (s, 4H), 2.58 (t, 2H, J=8 Hz), 2.48-2.12 (m, 6H), 2.04-1.93 (m, 2H), 1.77-1.62 (m, 8H), 1.62-1.51 (m, 6H), 1.49 (br, 2H), 1.41-1.30 (m, 7H), 1.29-0.86 (m, 13H). ¹³C NMR (100 MHz, CDCl₃): δ=171.67, 169.13, 168.15, 167.98, 70.61, 69.59, 56.56, 55.88, 49.37, 34.66, 31.00, 30.02, 29.75, 26.40, 25.71, 25.46, 25.22, 25.02, 20.47. ESI-HRMS: m/z=745.4748 ([M+H]₊), (calcd. 745.4746).

### REFERENCES

The following references, to the extent that they provide exemplary procedural or other details supplementary to those set forth herein, are specifically incorporated herein by reference.
Anderson, Practical Process Research & Development—A Guide for Organic Chemists, 2^{nd} ed., Academic Press, New York, 2012.
Handbook of Pharmaceutical Salts: Properties, and Use, Stahl and Wermuth Eds., Verlag Helvetica Chimica Acta, 2002.
Bae and Kim, Mater. Adv., 2021, 2, 3234-3250.
Bocheńska and Gdaniec, J. Incl. Phenom. Macrocycl. Chem., 1994, 20, 53-71.
Campion et al., Electrochem. Solid-State Lett., 2004, 7, A194.
Campion et al., J. Electrochem. Soc., 2005, 152, A2327.
Fyfe et al., Angew. Chem. Int. Ed., 1997, 36, 2068-2070.
Grützke et al., RSC Adv., 2015, 5, 43209-43217.
Harper et al., Nature, 2019, 575, 75-86.
Hayashida et al., Angew. Chem. Int. Ed., 2002, 41, 3423-3426.
Helbig et al., J. Clean. Prod., 2018, 172, 274-286.
Henderson, Anal. Chem., 2002, 74, 191-198.
Honeychuck and Hersh, Inorg. Chem., 1989, 28, 2869-2886.
Huang et al., J. Power Sources, 2018, 399, 274-286.
ISO Standard: 14:00-17:00, ISO/AWI 10655, https://www.iso.org/cms/render/live/en/sites/isoorg/contents/data/standard/08/37/83739.html, (accessed Apr. 8, 2022).
Kamenica et al., Sensors, 2017, 17, 2430.
Lee et al., Nature Chem, 2013, 5, 704-710.
Li et al., Green Chem., 2021, 23, 6139-6171.
Liu et al., RSCAdv., 2014, 4, 54525-54531.
Liu et al., ACS Energy Lett., 2021, 6, 2096-2102.
Masias et al., ACS Energy Lett., 2021, 6, 621-630.
Murdock et al., Adv. Energy Mater., 2021, 11, 2102028.
Olivetti et al., Joule, 2017, 1, 229-243.
Parimalam et al., J. Phys. Chem. C, 2017, 121, 22733-22738.
Simonin, Chem. Eng. J., 2016, 300, 254-263.
Smith, March's Advanced Organic Chemistry: Reactions, Mechanisms, and Structure, 7^{th} Ed., Wiley, 2013.
Terborg et al., J. Power Sources, 2013, 242, 832-837.
Thompson et al., Green Chem., 2020, 22, 7585-7603.
Tollefson, Nature, 2008, 456, 436-441.
Villemin and Raccurt, Coord. Chem. Rev., 2021, 435, 213801.
Wiemers-Meyer et al., Phys. Chem. Chem. Phys., 2016, 18, 26595-26601.
Wilken et al., RSC Adv., 2013, 3, 16359-16364.
Yan et al., Chem. Sci., 2022, 13, 4283-4294.
Yang et al., J. Power Sources, 2006, 161, 573-579.
Younesi et al., Energy Environ. Sci., 2015, 8, 1905-1922.
Zeng et al., Crit. Rev. Environ. Sci. Technol., 2014, 44, 1129-1165.
Zheng et al., Electrochim. Acta, 2016, 196, 169-188.

What is claimed is:

1. A method of obtaining a purified metal or a metal salt of interest from a composition comprising at least a metal or metal salt to be purified, the method comprising:
(A) contacting the composition with a metal selective chelating agent in the presence of an aprotic solvent to form a metalated metal selective chelating agent; and
(B) exposing the metalated metal selective chelating agent to a protic solvent to form a purified metal sample.

2. The method of claim 1, wherein the composition is a recycling composition.

3. The method of claim 2, wherein the composition is electronic waste.

4. The method according to any one of claims 1-3, wherein the composition comprises two or more additional metals or metal salts other than the metal or metal salt of interest.

5. The method according to any one of claims 1-4, wherein the metal or metal salt of interest is a monovalent metal salt, a divalent metal salt, or a trivalent metal salt.

6. The method according to any one of claims 1-5, wherein the monovalent metal salt is a monovalent alkali metal salt.

7. The method according to any one of claims 1-5, wherein the metal or metal salt of interest is a divalent metal salt.

8. The method according to any one of claims 1-5, wherein the metal or metal salt of interest is an actinide or a lanthanide.

9. The method according to any one of claims 1-8, wherein the metal or metal salt of interest is a salt with a counter anion.

10. The method of claim 9, wherein the counter anion is a weakly coordinating anion.

11. The method of claim 9, wherein the counter anion is a halide.

12. The method of claim 9, wherein the counter anion is a nitrate.

13. The method according to any one of claims 1-12, wherein the metal selective chelating agent comprises a chelating unit of the formula: 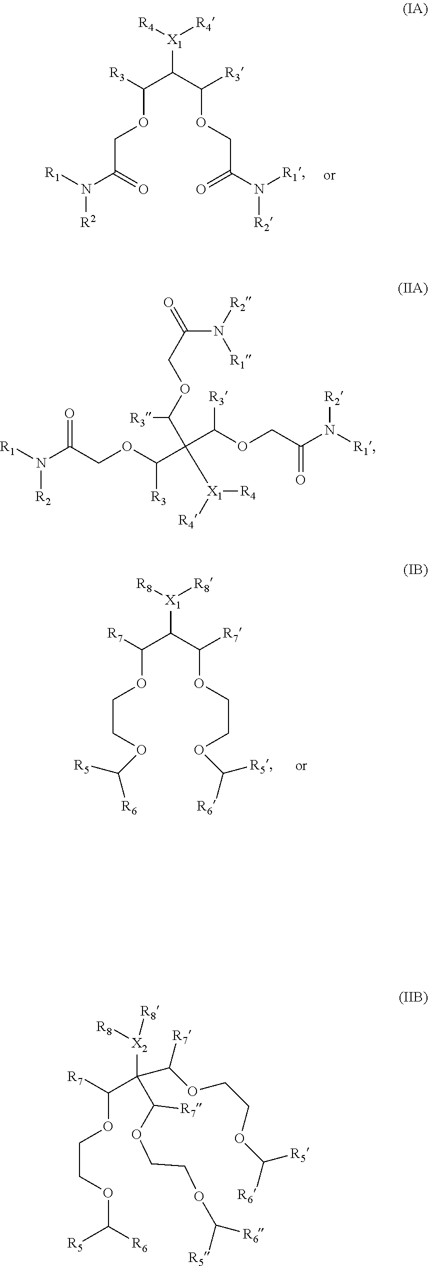
wherein:
R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₃″, R₇, R₂′, and R₂″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
R₄, R₄′, R₈, and R₈′ are hydrogen, a bond to a support, or taken together as defined above; and
X₁ and X₂ are each independently O or N.

14. The method according to any one of claims 1-13, wherein the metal selective chelating agent comprises a chelating unit of the formula: 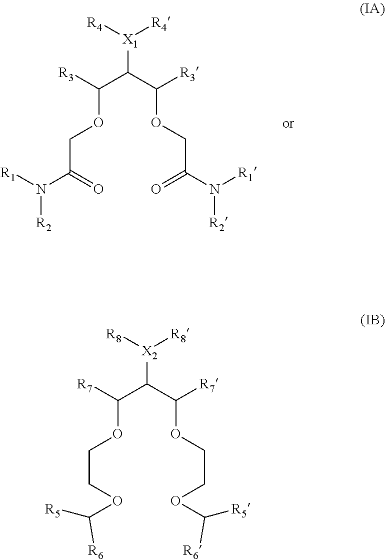
wherein:
R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₇, and R₇′ are each independently hydrogen or R₃ and R₄, R₃′ and R₄′, R₇ and R₈, or R₇′ and R₈′ are joined together to form a 3-8 membered cycloalkane ring or a 3-8 membered heterocycloalkane ring;
R₄, R₄′, R₈, and R₈′ are hydrogen, a bond to a support, or taken together as defined above; and
X₁ and X₂ are each independently O or N.

15. The method of claim 14, wherein the chelating unit is further defined as: 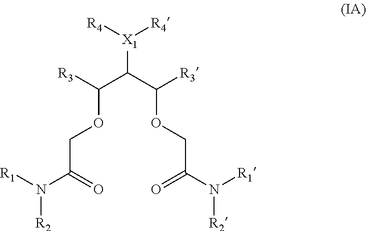
wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
R₃ and R₃′ are each independently hydrogen or R₃ and R₄ or R₃′ and R₄′ are joined together to form a 3-8 membered cycloalkane ring or a 3-8 membered heterocycloalkane ring;
R₄ and R₄′ are hydrogen, a bond to a support, or taken together as defined above; and
X₁ is O or N.

16. The method of claim 13, wherein the chelating unit is further defined as: 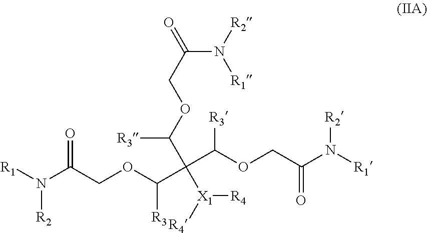
wherein:
R₁, R₁′, R₁″, R₂, R₂, and R₂″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, and R₃″ are each independently hydrogen or R₃ and R₄, R₃′ and R₄′, and R₃″ and R₄″ are joined together to form a 3-8 membered cycloalkane ring or a 3-8 membered heterocycloalkane ring;
R₄ and R₄′ are hydrogen, a bond to a support, or taken together as defined above; and
X₁ and X₂ are each independently O or N.

17. The method of either claim 14 or claim 15, wherein the chelating unit is further defined as: 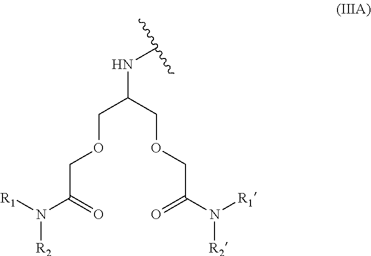
wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to a support.

18. The method of either claim 13 or claim 16, wherein the chelating unit is further defined as: 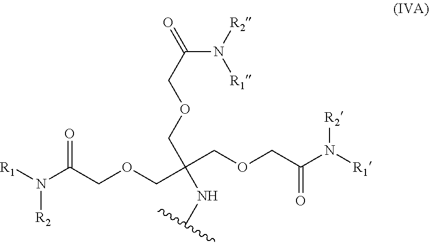
wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

19. The method of claim 14, wherein the chelating unit is further defined as: 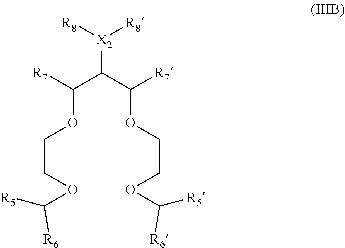
wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₇ and R₇′ are each independently hydrogen or R₇ and R₈ or R₇′ and R₈′ are joined together to form a 3-8 membered cycloalkane ring or a 3-8 membered heterocycloalkane ring;
R₈ and R₈′ are hydrogen, a connection to a resin or polymer, or taken together as defined above; and
X₂ is O or N.

20. The method of claim 13 further defined as: 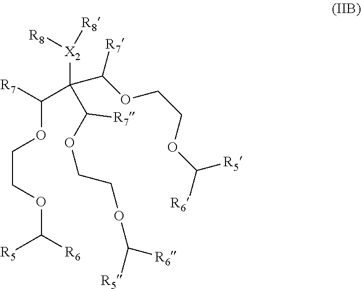
wherein:
R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₇, R₇′, and R₇″ are each independently hydrogen or R₇ and R₈, R₇′ and R₈′, or R₇″ and R₈″ are joined together to form a 3-8 membered cycloalkane ring or a 3-8 membered heterocycloalkane ring;
R₈ and R₈′ are hydrogen, a bond to a support, or taken together as defined above; and
X₁ and X₂ are each independently O or N.

21. The method of either claim 14 or claim 19 further defined as: 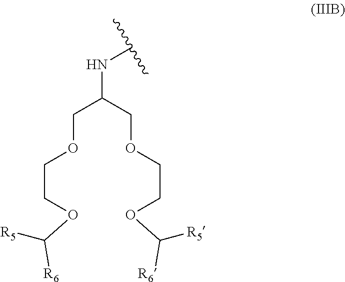
wherein:
R₅, R₅′, R₆, and R₆′ are each independently cycloalkyl_{(C≤12)}, aryl_{(C≤12)}, heteroaryl_{(C<12)}, heterocycloalkyl_{(C<12)}, or a substituted version of any of these groups; and
the open valence is connected to a support.

22. The method of claim 20 further defined as: 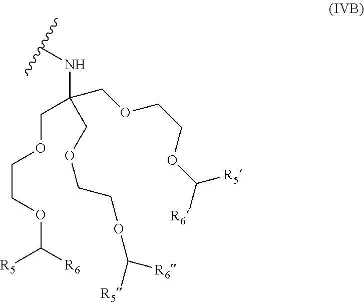
wherein:
R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

23. The method according to any one of claims 13-18, wherein R₁ is cycloalkyl_{(C≤12)} or substituted cycloalkyl_{(C≤12)}.

24. The method according to any one of claims 13-18 and 23, wherein R₁′ is cycloalkyl_{(C≤12)} or substituted cycloalkyl_{(C≤12)}.

25. The method according to any one of claims 13-18, 23, and 24, wherein R₁″ is cycloalkyl_{(C≤12)} or substituted cycloalkyl_{(C≤12)}.

26. The method according to any one of claims 13-18, and 23-25, wherein R₂ is cycloalkyl_{(C≤12)} or substituted cycloalkyl_{(C≤12)}.

27. The method according to any one of claims 13-18 and 23-26, wherein R₂′ is cycloalkyl_{(C≤12)} or substituted cycloalkyl_{(C≤12)}.

28. The method according to any one of claims 13-18 and 23-27, wherein R₂″ is cycloalkyl_{(C≤12)} or substituted cycloalkyl_{(C≤12)}.

29. The method according to any one of claims 13, 14, and 19-22, wherein R₅ is cycloalkyl_{(C≤12)} or substituted cycloalkyl_{(C≤12)}.

30. The method according to any one of claims 14, 19-22, and 29-29, wherein R₅′ is cycloalkyl_{(C≤12)} or substituted cycloalkyl_{(C≤12)}.

31. The method according to any one of claims 14, 19-22, and 29-30, wherein R₆ is cycloalkyl_{(C≤12)} or substituted cycloalkyl_{(C≤12)}.

32. The method according to any one of claims 14, 19-22, and 29-31, wherein R₆′ is cycloalkyl_{(C≤12)} or substituted cycloalkyl_{(C≤12)}.

33. The method according to any one of claims 14, 19-22, and 29-31, wherein R₆″ is cycloalkyl_{(C≤12)} or substituted cycloalkyl_{(C≤12)}.

34. The method according to any one of claims 1-33, wherein the metal selective chelating agent further comprises a support.

35. The method of claim 34, wherein the support comprises a polymer.

36. The method according to any one of claims 34-35, wherein the support is a bead, resin, or surface.

37. The method according to any one of claims 34-36, wherein the polymer is a hydrophobic polymer.

38. The method according to any one of claims 34-37, wherein the metal selective chelating agent further comprises two or more chelating units attached to the support.

39. The method of claim 38, wherein the metal selective chelating agent further comprises a capping agent on any remaining reactive functional groups on the support.

40. The method according to any one of claims 34-37, wherein the metal selective chelating agent further comprises a linker between the chelating unit and the support.

41. The method of claim 40, wherein the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof.

42. The method according to any one of claims 40-41, wherein the spacer is an alkanediyl_{(C≤12)} or a substituted alkanediyl_{(C≤12)}.

43. The method according to any one of claims 1-42, wherein the method is conducted at a temperature above −80° C.

44. The method according to any one of claims 1-43, wherein the method is carried out at a temperature from about −30° C. to about 100° C.

45. The method according to any one of claims 1-44, wherein the aprotic solvent is an ether.

46. The method according to any one of claims 1-45, wherein the aprotic solvent is a nitrogen containing solvent.

47. The method according to any one of claims 1-46, wherein the protic solvent is a hydroxy containing solvent.

48. The method according to any one of claims 1-47, wherein the protic solvent is admixed with water.

49. The method according to any one of claims 1-48, wherein the method is conducted at a pressure from about 0.1 atm to about 5 atm.

50. The method according to any one of claims 1-49, wherein the purified metal sample comprises at least 90% of the desired metal or metal salt.

51. A composition comprising:
(A) a support; and
(B) a chelating unit of the formula: 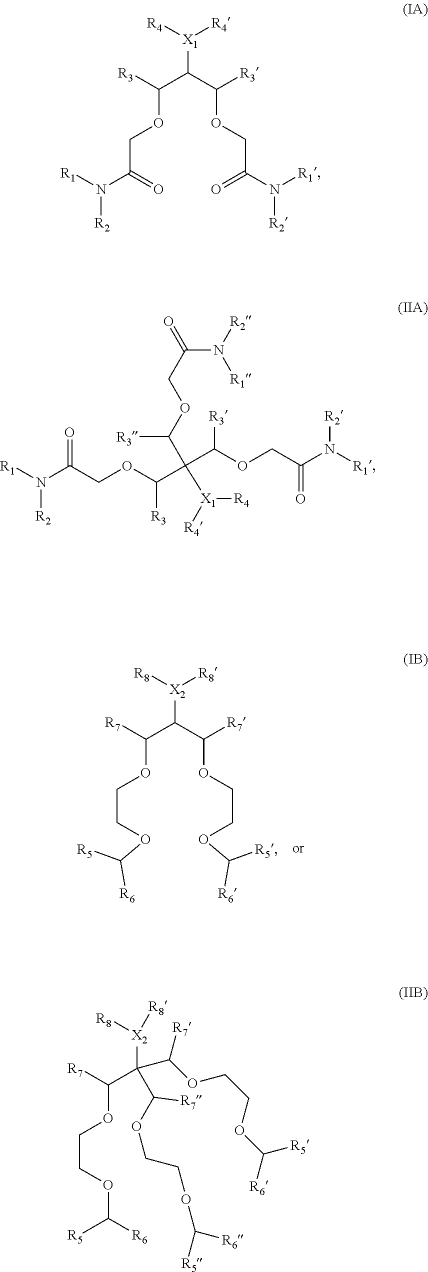
wherein:
R₁, R₁′, R₁″, R₂, R₂′, R₂″, R₅, R₅′, R₅″, R₆, R₆′, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₃″, R₇, R₇′, and R₇″ are each independently hydrogen or R₃ and R₄, R₃′ and R₄′, R₃″ and R₄″, R₇ and R₈, R₇′ and R₈′, or R₇″ and R₈″ are joined together to form a 3-8 membered cycloalkane ring or a 3-8 membered heterocycloalkane ring;
R₄, R₄′, R₈, and R₈′ are hydrogen, a connection to a resin or polymer, or taken together as defined above; and
X₁ and X₂ are each independently O or N.

52. The composition of claim 51, wherein the chelating unit is further defined as: 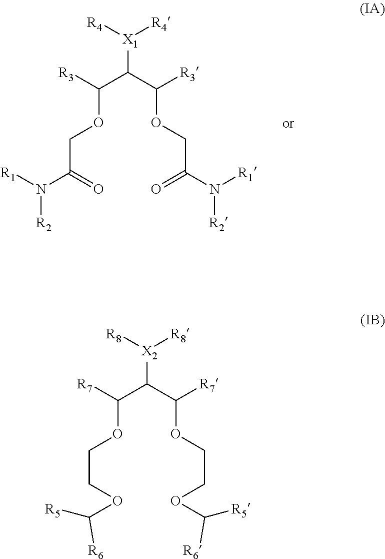
wherein:
R₁, R₁′, R₂, R₂′, R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, R₇, and R₇′ are each independently hydrogen or R₃ and R₄, R₃′ and R₄, R₇ and R₈, or R₇′ and R₈′ are joined together to form a 3-8 membered cycloalkane ring or a 3-8 membered heterocycloalkane ring;
R₄, R₄′, R₈, and R₈′ are hydrogen, a bond to a support, or taken together as defined above; and
X₁ and X₂ are each independently O or N.

53. The composition of either claim 51 or claim 52, wherein the chelating unit is further defined as: 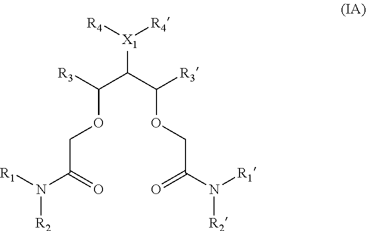
wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups;
R₃ and R₃′ are each independently hydrogen or R₃ and R₄ or R₃′ and R₄′ are joined together to form a 3-8 membered cycloalkane ring or a 3-8 membered heterocycloalkane ring;
R₄ and R₄′ are hydrogen, a connection to a resin or polymer, or taken together as defined above; and
X₁ is O or N.

54. The composition of either claim 51 or claim 52 further defined as: 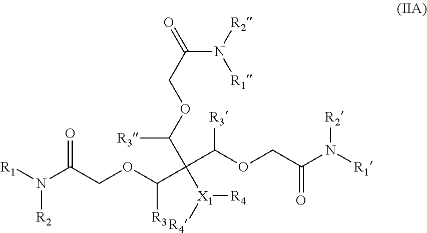
wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups;
R₃, R₃′, and R₃″ are each independently hydrogen or R₃ and R₄, R₃′ and R₄′, and R₃″ and R₄″ are joined together to form a 3-8 membered cycloalkane ring or a 3-8 membered heterocycloalkane ring;
R₄ and R₄′ are hydrogen, a bond to a support, or taken together as defined above; and
X₁ and X₂ are each independently O or N.

55. The composition of either claim 51 or claim 53, wherein the chelating unit is further defined as: 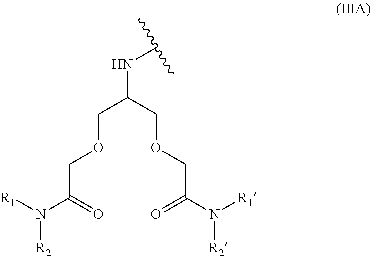
wherein:
R₁, R₁′, R₂, and R₂′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to the support.

56. The composition according to any one of claims 51, 52, or 54, further defined as: 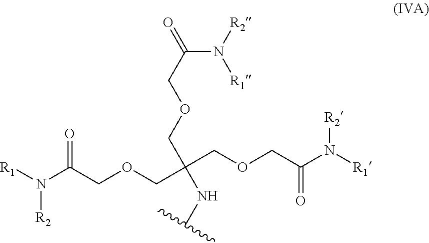
wherein:
R₁, R₁′, R₁″, R₂, R₂′, and R₂″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

57. The composition of claim 51, wherein the chelating unit is further defined as: 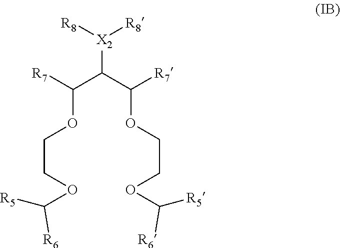
wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups;
R₇ and R₇′ are each independently hydrogen or R₇ and R₈ or R₇′ and R₈′ are joined together to form a 3-8 membered cycloalkane ring or a 3-8 membered heterocycloalkane ring;
R₈ and R₈′ are hydrogen, a connection to a resin or polymer, or taken together as defined above; and
X₂ is O or N.

58. The composition of claim 51 further defined as: 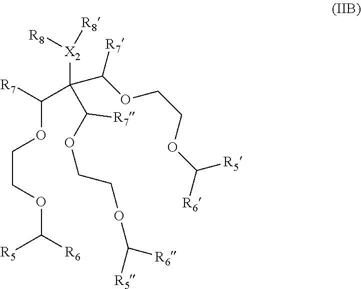
wherein:
R₅, R₅′, R₅″, R₆, R₆, and R₆″ are each independently cycloalkyl_{(C≤12)}, aryl_{(C≤12)}, heteroaryl_{(C≤12)}, heterocycloalkyl_{(C≤12)}, or a substituted version of any of these groups;
R₇, R₇′, and R₇″ are each independently hydrogen or R₇ and R₈, R₇′ and R₈′, or R₇″ and R₈″ are joined together to form a 3-8 membered cycloalkane ring or a 3-8 membered heterocycloalkane ring;
R₈ and R₈′ are hydrogen, a bond to a support, or taken together as defined above; and
X₁ and X₂ are each independently O or N.

59. The composition of either claim 51 or claim 57 further defined as: 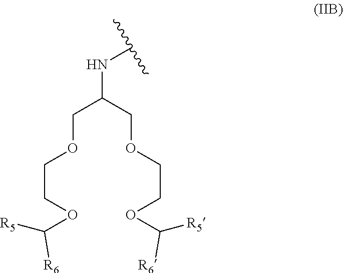
wherein:
R₅, R₅′, R₆, and R₆′ are each independently cycloalkyl_{(C≤12)}, aryl_{(C≤12)}, heteroaryl_{(C≤12)}, heterocycloalkyl_{(C≤12)}, or a substituted version of any of these groups; and
the open valence is connected to the support.

60. The composition of claim 58 further defined as: 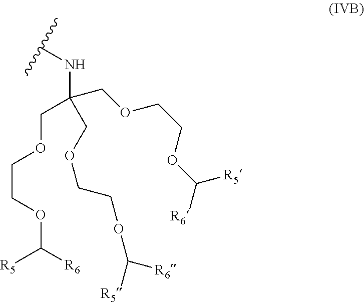
wherein:
R₅, R₅′, R₅″, R₆, R₆, and R₆″ are each independently cycloalkyl_{(C≤12)}, aryl_{(C≤12)}, heteroaryl_{(C≤12)}, heterocycloalkyl_{(C≤12)}, or a substituted version of any of these groups; and
the open valance is connected to a support.

61. The composition according to any one of claims 51-56, wherein R₁ is cycloalkyl_{(C≤12)} or substituted cycloalkyl_{(C≤12)}.

62. The composition according to any one of claims 51-56 and 61, wherein R₁′ is cycloalkyl_{(C≤12)} or substituted cycloalkyl_{(C≤12)}.

63. The composition according to any one of claims 51-56 and 61-62, wherein R₁″ is cycloalkyl_{(C≤12)} or substituted cycloalkyl_{(C≤12)}.

64. The composition according to any one of claims 51-56 and 61-63, wherein R₂ is cycloalkyl_{(C≤12)} or substituted cycloalkyl_{(C≤12)}.

65. The composition according to any one of claims 51-56 and 61-64, wherein R₂′ is cycloalkyl_{(C≤12)} or substituted cycloalkyl_{(C≤12)}.

66. The composition according to any one of claims 51-56 and 61-65, wherein R₂″ is cycloalkyl_{(C≤12)} or substituted cycloalkyl_{(C≤12)}.

67. The composition according to any one of claims 51, 52, and 57-60, wherein R₅ is cycloalkyl_{(C≤12)} or substituted cycloalkyl_{(C≤12)}.

68. The composition according to any one of claims 51, 57-60, and 67-67, wherein R₅′ is cycloalkyl_{(C≤12)} or substituted cycloalkyl_{(C≤12)}.

69. The composition according to any one of claims 51, 57-60, and 67-68, wherein R₅″ is cycloalkyl_{(C≤12)} or substituted cycloalkyl_{(C≤12)}.

70. The composition according to any one of claims 51, 57-60, and 67-68, wherein R₆ is cycloalkyl_{(C≤12)} or substituted cycloalkyl_{(C≤12)}.

71. The composition according to any one of claims 51, 57-60, and 67-70, wherein R₆′ is cycloalkyl_{(C≤12)} or substituted cycloalkyl_{(C≤12)}.

72. The composition according to any one of claims 51, 57-60, and 67-71, wherein R₆″ is cycloalkyl_{(C≤12)} or substituted cycloalkyl_{(C≤12)}.

73. The composition according to any one of claims 51-72, wherein the support is a hydrophobic support.

74. The composition according to any one of claims 51-73, wherein the support comprises a polymer.

75. The composition according to any one of claims 51-74, wherein the composition further comprises two or more chelating units attached to the support.

76. The composition of claim 75, wherein the metal selective chelating agent further comprises a capping agent on any remaining reactive functional groups on the support.

77. The composition according to any one of claims 51-76, wherein the chelating unit and the support are joined by a linker between the chelating unit and the support.

78. The composition of claim 77, wherein the linker comprises two joining groups selected from an azide, a carbon-carbon triple bond, a carboxylic acid, an amine, a hydroxy, an isocyanate, or an isothiocyanate joined by a spacer, wherein the spacer is alkanediyl_{(C≤12)}, alkenediyl_{(C≤12)}, cycloalkanediyl_{(C≤12)}, arenediyl_{(C≤12)}, or a substituted version thereof.

79. The composition of claim 78, wherein the spacer is an alkanediyl_{(C≤12)} or a substituted alkanediyl_{(C≤12)}.

80. A method of purifying a metal comprising exposing a composition containing the metal to purified to a composition according to any one of claims 51-79.

81. A method of recycling the metal ions in a battery comprising contacting the components of the battery to a composition according to any one of claims 51-79.
